(19) United States
(12) Patent Application Publication
(10) Pub. No.: US 2026/0180878 A1
(43) Pub. Date: Jun. 25, 2026

(54) CLASSIFICATION OF NETWORK TRAFFIC USING A CENTRALIZED CACHE

(71) Applicant: Hewlett Packard Enterprise Development LP, Spring, TX (US)

(72) Inventors: Avalur Deepakparasar, Bangalore (IN); Naveenkumar Vijayakumar, Bangalore (IN); Matam Uday Kiran, Bangalore (IN); Hardik Sanghavi, Bangalore (IN)

(21) Appl. No.: 19/052,833

(22) Filed: Feb. 13, 2025

(30) Foreign Application Priority Data
Dec. 20, 2024 (IN) 202441101261

(51) Int. Cl. H04L 43/026; H04L 41/04

(52) U.S. Cl. CPC H04L 43/026; H04L 41/04

(57) ABSTRACT

In certain implementations, a computing device includes a centralized cache storing classification information for network traffic associated with access points (APs), one or more processors, and one or more non-transitory computer-readable storage media storing programming for execution by the one or more processors. The programming includes instructions to receive a classification request from a first AP for network traffic associated with a client device, and in response, determine whether the centralized cache includes classification information for the network traffic. The programming includes instructions to obtain, in response to determining that the centralized cache includes the classification information, the classification information from the centralized cache. The programming includes instructions to obtain, in response to determining that the centralized cache does not include the classification information, the classification information from a traffic classification service. The programming includes instructions to transmit the classification information from the traffic classification service to the first AP.

### BACKGROUND

Communication networks are a pervasive and essential part of the daily operations of businesses of all sizes. A communication network may include various electronic devices, such as client devices, access points (APs), gateways, network controllers, routers, and switches, that are able to communicate with one another via one or more communication interfaces. The communication network may be a wired communication network, a wireless communication network, or a combination of wired and wireless communication networks.

### BRIEF DESCRIPTION OF THE DRAWINGS

For a more complete understanding of this disclosure, and advantages thereof, reference is now made to the following descriptions taken in conjunction with the accompanying drawings, in which:

FIGS. 1A-1B illustrate an example system for classification of network traffic using a centralized cache of network information, according to certain implementations;

FIG. 2 illustrates an example signaling flow for classification of network traffic using a centralized cache of network information, according to certain implementations;

FIG. 3 illustrates an example method for classification of network traffic using a centralized cache of network information, according to certain implementations;

FIG. 4 illustrates an example method for classification of network traffic using a centralized cache of network information, according to certain implementations;

FIG. 5 illustrates an example signaling flow for classification of network traffic using a centralized cache of network information, according to certain implementations;

FIG. 6 illustrates an example method for classification of network traffic using a centralized cache of network information, according to certain implementations;

FIG. 7 illustrates an example method for classification of network traffic using a centralized cache of network information, according to certain implementations; and

FIG. 8 illustrates a system including additional details of certain components of FIGS. 1A-1B, according to certain implementations.

### DESCRIPTION

Network environments often include multiple APs or other edge network devices that provide connectivity for client devices. Client devices may connect to a communication network through an AP (e.g., a wireless AP, or WAP) or another edge network device. Client devices may generate network traffic, such as by accessing applications (e.g., applications hosted and run on the client device that generate network traffic and/or web applications that are accessed via a browser on the client device), websites, or other content, and that network traffic may traverse the AP en route to the communication network. When client devices generate network traffic, traffic classification may be performed to facilitate applying appropriate access controls and/or other policies to the network traffic. For example, the classification may be used to enforce administrative policies, such as blocking certain categories of websites or limiting bandwidth for specific types of traffic.

The APs or other edge network devices may facilitate classifying the network traffic to enforce access control policies and security measures. To obtain this classification information, these APs typically query third-party network traffic classification services (e.g., through vendors such as BRIGHTCLOUD, QOSMOS, IPOQUE, and/or others) that provide web or application classification information for network traffic. The traffic classification information may include category information (e.g., social networking, streaming media), web reputation data (e.g., trustworthy, moderate risk, high risk), and/or other suitable classification information of the network traffic.

When a client device generates network traffic, the AP handling the network traffic for that client device may individually query a third-party network traffic classification service to obtain classification information for the network traffic and store the classification results. Each AP may maintain its own local cache of obtained classification information, but this local cache and/or the contents of the local cache might not be shared across APs or with other entities in the communication network. That is, this network traffic classification typically is performed by each individual AP querying third-party classification services and storing the results in a local cache of the individual AP, even if other APs in a network have previously obtained classification information for analogous network traffic. This leads to redundant network traffic classification requests, even within the same customer environment or network cluster.

The approach of having the APs individually obtain, locally store, and not share classification information from the third-party network traffic classification services may present certain drawbacks, such as certain inefficiencies across a communication network. As a first example drawback, some scenarios may result in redundant classification requests. For example, when a client device roams between APs or when different client devices on different APs generate analogous network traffic (e.g., access the same content, such as the same URL), each AP independently may request classification from third-party classification service, even if another AP has already classified that network traffic, resulting in redundant classification operations that unnecessarily consume resources. As another example drawback, some scenarios may result in unutilized intelligence. For example, local classification intelligence generated on one AP would not be shared across other APs in a communication network, which may lead to inefficient use of already-obtained classification data. This siloed approach means that valuable local intelligence generated by one AP is not shared or utilized by others within the same customer's network or cluster. As another example drawback, some scenarios may increase network overhead. For example, the potential repeated communication between APs and third-party vendors may increase network traffic. As another example drawback, some scenarios may increase costs. For example, multiple API calls to third-party network traffic classification services for the same classification may increase operational costs. As another example drawback, at least some edge network devices (e.g., at least some APs) may have heightened resource constraints. For example, APs may have limited memory resources, constraining their ability to maintain comprehensive local network traffic classification caches. Consequently, the network as a whole operates less efficiently than it could, missing opportunities to leverage existing knowledge and potentially impacting performance and user experience.

Certain implementations of this disclosure provide a system for storing classification information for network traffic in a centralized classification cache. Some communication networks may include a network management system (NMS) or other centralized management network device, referred to generally as an NMS, that manages and monitors the communication network. Certain implementations of this disclosure leverage this NMS as the centralized network device that collects and stores classification information for network traffic.

In certain implementations, a centralized network device, such as an NMS, serves as the primary interface with third-party network traffic classification services. The NMS may manage numerous APs, and may include a centralized cache that stores at least some classification information for network traffic that might be generated by client devices of the APs. When an AP is to classify network traffic of a client device, the AP may query the NMS for classification information for the network traffic, and the NMS may determine whether the centralized cache of the NMS includes the classification information. If the centralized cache of the NMS includes the classification information for the network traffic, the NMS may return the classification information to the AP.

If the centralized cache of the NMS does not include the classification information for the network traffic, the NMS may query a network traffic classification service (e.g., a third-party classification vendor) for the classification information for the network traffic, store the classification information obtained from the network traffic classification service in the centralized cache of the NMS, and transmit the obtained classification information for the network traffic to the requesting AP. The NMS may be performing a similar service for some or all of the numerous APs managed by the NMS, and thus may develop an extensive centralized cache of network information over time. The AP then may process the network traffic according to the classification information for the network traffic, such as by enforcing one or more network traffic management policies. This solution also may provide enhanced security, as requests for classification information are channeled through the NMS.

In certain implementations, the NMS acts as an initial cache check point, but the AP still might request classification information from the network traffic classification service in certain scenarios. Again, the NMS may manage numerous APs, and may include a centralized cache that stores at least some classification information for network traffic that might be generated by client devices of the APs. When an AP is to classify network traffic of a client device, the AP may query the NMS for classification information for the network traffic, and the NMS may determine whether the centralized cache of the NMS includes the classification information.

If the centralized cache of the NMS includes the classification information for the network traffic, the NMS may return the classification information to the AP. If the centralized cache of the NMS does not include the classification information for the network traffic, the NMS may transmit a null response to the AP indicating that the NMS lacks the classification information for the network traffic. In response to the null response, the AP may directly query the network traffic classification service to obtain the classification information for the network traffic. The AP may store the obtained classification information in a local cache of the AP that stores classification information for network traffic. In certain implementations, the AP may transmit the obtained classification information for the network traffic to the NMS so that the NMS also can update the centralized cache of the NMS with the obtained classification information for the network traffic, which may reduce calls to the network traffic classification service by the AP or other APs in the future. The AP then may process the network traffic according to the classification information for the network traffic, such as by enforcing one or more network traffic management policies.

In certain implementations, the NMS may periodically (e.g., at any suitable regular or irregular intervals) obtain (e.g., preload) classification information from the network traffic classification service to be stored in the centralized cache of the NMS, which also can be used to expedite responding to APs with responsive classification information. Additionally or alternatively, in certain implementations, the APs may periodically (e.g., at any suitable regular or irregular intervals) obtain cache updates from the NMS.

Certain implementations may provide none, some, or all of the following technical advantages. Relative to distributed caching approaches, certain implementations may reduce, potentially significantly, the number of API calls made to third-party classification vendors, which may result in substantial cost savings for network operators. Since classification results can be shared across multiple access points through the centralized cache, the system may eliminate redundant classification requests that would otherwise occur when client devices roam between access points or when different client devices access the same content through different access points.

The centralized approach may also provide security benefits in certain implementations. For example, when the network management system serves as the primary interface with third-party vendors, access points need not have direct external network connectivity for traffic classification purposes. This may reduce the attack surface of the network and allow for the implementation of more robust security protocols between the network management system and third-party vendors, as the network management system may have greater computational resources than individual access points.

In certain implementations, the system may reduce the memory requirements for individual access points, as they need not maintain comprehensive local classification caches. This may result in more lightweight access point firmware and more efficient use of access point resources. Additionally, the network management system may periodically push relevant cached classifications to access points, which may further improve classification response times for frequently accessed content.

The centralized caching system may also provide network administrators with improved visibility into network traffic patterns across their entire network. In certain implementations, this consolidated view of classification data may enable administrators to make more informed decisions about network policy and resource allocation.

The system’s flexibility in implementation approaches may allow organizations to choose the most appropriate architecture based on their specific needs. For example, organizations with stringent security requirements may opt for an implementation where all third-party communication is channeled through the network management system, while those prioritizing rapid classification may choose an implementation that allows direct access point communication with third-party vendors as a fallback mechanism.

In certain implementations, the ability to pre-load classification datasets from third-party vendors into the centralized cache may further reduce external API calls and improve classification response times. This may be particularly beneficial for commonly accessed content and may help organizations better manage their classification service costs.

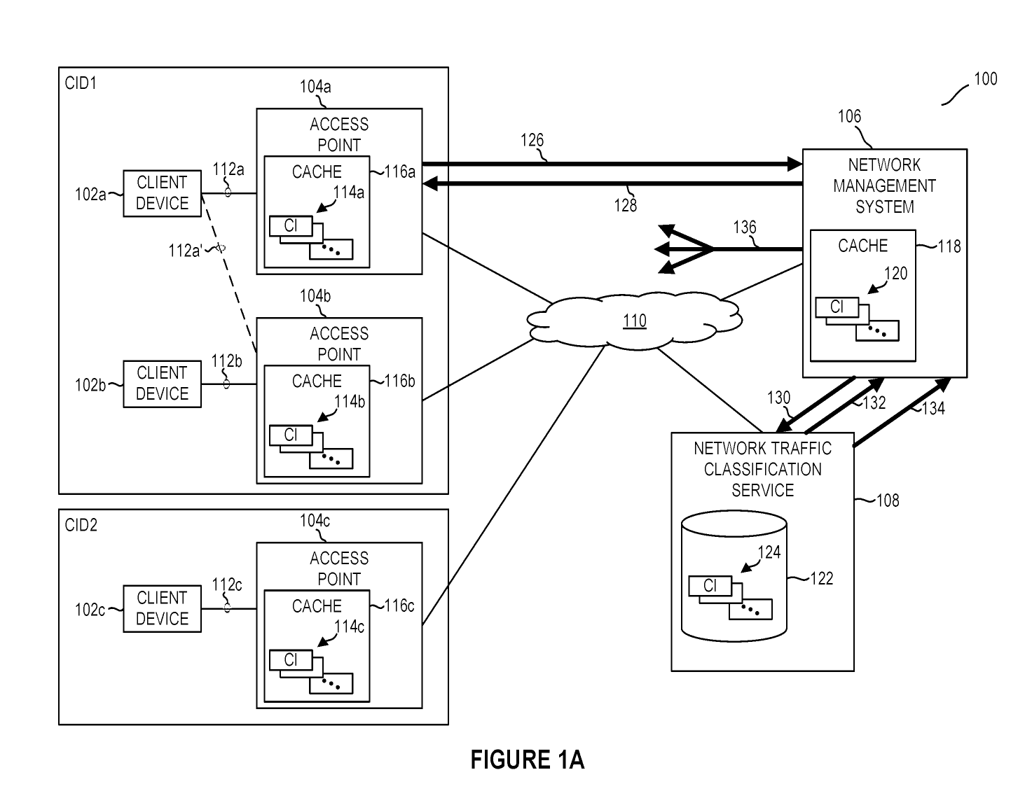

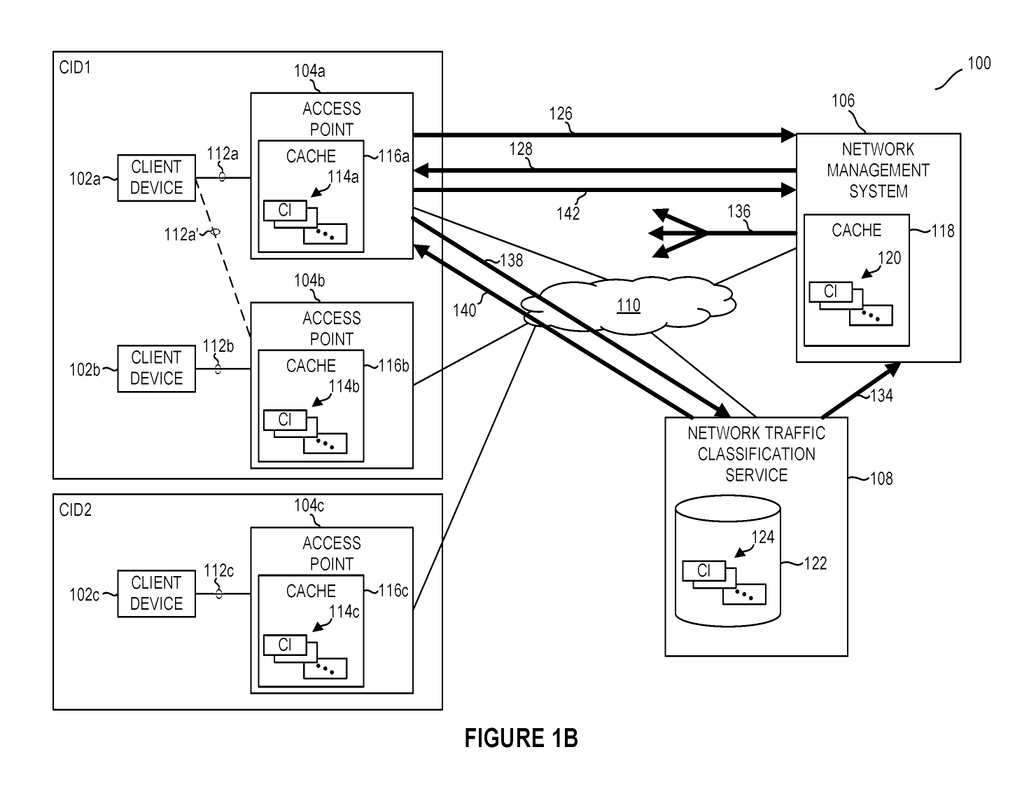

Turning to the figures, FIGS. 1A-1B illustrate an example system 100 for classification of network traffic using a centralized cache of network information, according to certain implementations. As will be described in greater detail below, FIG. 1A illustrates an example in which a network management system serves as a primary component for obtaining and maintaining classification information for network traffic from a network traffic classification service, and FIG. 1B illustrates an example, in which an access point may be more involved in obtaining classification information for network traffic from a network traffic classification service. It should be understood that the implementations of FIGS. 1A and 1B may be combined, in whole or in part.

In both FIGS. 1A and 1B, system 100 includes client devices 102a-102c (referred to generally as client device(s) 102), access points 104a-104c (referred to generally as access point(s) 104 or AP(s) 104), a network management system 106, and a network traffic classification service 108, all of which may communicate via network 110. Although system 100 is shown to have particular components in a particular arrangement, this disclosure contemplates other implementations of system 100. Furthermore, although system 100 is show to include particular numbers of client devices 102, access points 104, network management systems 106, and network traffic classification services 108, this disclosure contemplates system 100 including any suitable numbers of client devices 102, access points 104, network management systems 106, and network traffic classification services 108.

Client devices 102 may represent any types of computing devices capable of reading machine-executable instructions and network connectivity. Examples of a computing device may include a server, a desktop computer, a notebook computer, a tablet computer, a thin client, a mobile device, a personal digital assistant (PDA), a smart phone, a printer, a thermostat or other Internet-of-Things (IoT) device, or any other suitable type of computing device. In certain implementations, client device 102 may include a network interface (e.g., a network interface card (NIC)) that allows client device 102 to perform communication with another device, such as one or more access points 104. In certain implementations, the network interface may facilitate wireless communications, such as with one or more access points 104.

Client devices 102 may generate network traffic, examples of which are labeled network traffic 112a, 112a', 112b, and 112c (referred to generally as network traffic 112). For example, client devices 102 may generate network traffic 112 by accessing applications (e.g., applications hosted and run on a client device 102 that generate network traffic 112 and/or web applications that are accessed via a browser on client device 102), websites, or other content, and that network traffic may traverse an access point 104 en route to a communication network (e.g., a portion of network 110). Network traffic 112 may include a network communication generated by an application hosted on a client device 102, a network communication generated by a web application, a network communication generated to interact (via client device 102) with a website, or other suitable types of network communications.

Network traffic 112 may include metadata that can be extracted from or otherwise determined from network traffic 112. The metadata may include certain attributes of the network traffic 112 that may be used to identify the network traffic. For example, the metadata may include a uniform resource locator (URL) of a web site or other web resource being accessed by client device 102, a domain name of a web site or other web resource being accessed by client device 102, a packet pattern of a network communication generated by client device 102, domain name system (DNS) caching information of a network communication generated by client device 102, an application identifier of an application on client device 102 that generated the network traffic 112, an application identifier of an web application being accessed by client device 102, and/or any other suitable information, some of which may overlap in type.

Access points 104 may each include a device, such as a router or wireless router, that allows devices (e.g., client devices 102), which may be wireless devices, to connect to a communication network, such as to access the Internet. Access points 104 may each act as radio transmitters for a wireless local area network (WLAN). Access points 104 may each translate network traffic into radio signals and transmit those signals to wireless enabled processing devices. For example, access points 104 may each act as a bridge to a wired local area network (LAN). Although referred to primarily as an access point or wireless access point, access points 104 may include any type of edge network device that is able to facilitate internet connectivity for another end device (e.g., a client device 102).

Network traffic 112 may traverse an access point 104 en route to a communication network (e.g., network 110), and access points 104 may be configured to enforce certain policies to network traffic 112. For example, those policies may include security measures, access controls, and/or other policies. As just one particular example, an access point 104 may enforce a policy that prevents or otherwise restricts (e.g., to a particular group of users) access to certain web sites.

To facilitate enforcing these policies, an access point 104 (e.g., the access point 104 to which the client device 102 that generated the network traffic 112 being evaluated is connected) may performing traffic classification on the network traffic 112. For example, the classification may be used to enforce administrative policies, such as blocking certain categories of websites or limiting bandwidth for specific types of traffic.

Access points 104 may interact with one or more other components of system 100 to perform this traffic classification, as will be described in greater detail below. For example, classification of network traffic 112 may be performed according to classification information for network traffic 112. The classification information may provide a network traffic profile for network traffic 112 and may include traffic category information, traffic reputation information, and/or any other suitable information.

Traffic category information may specify a type of site and/or content associated with the network traffic 112. Example categories/types of network traffic 112 may include social networking, news media, search, gaming, media streaming, and/or other suitable types of network traffic 112. As just one example of how traffic category information might be used by an access point 104 for enforcing a network traffic policy, certain network traffic policies may specify that certain categories of network traffic 112 are to be blocked (e.g., an office could block media streaming sites).

Traffic reputation information may include a rating or other indicator of the trustworthiness and/or risk level posed by accessing the site and/or content associated with network traffic 112. In an example of traffic reputation information in which reputation levels are used, example reputation levels may include low risk, moderate risk, and high risk, though any suitable numbers and types of levels may be used. The traffic reputation information could be related to traffic categories (e.g., certain categories are assigned a particular reputation level) or could be site/content specific (e.g., reputation levels are assigned on a site/content-by-site/content basis). As just one example of how traffic reputation information might be used by an access point 104 for enforcing a network traffic policy, certain network traffic policies may specify that network traffic 112 associated with sites/content lacking a certain reputation level are to be blocked (e.g., an office could block any site that has a high risk reputation level).

In certain implementations, network traffic category information and network traffic reputation information may serve different purposes and/or provide more flexibility in defining and enforcing network traffic policies. For example, a particular traffic policy might specify that a certain category of network traffic 112 is to be blocked regardless of the reputation level of the network traffic 112. As a particular example, a specific media streaming site may have a low risk reputation, but the network traffic policy still might cause an access point 104 to block the network traffic 112 due to the network traffic category (e.g., block network traffic 112 having a media streaming traffic category).

The classification information may be stored in any suitable format. For example, the classification information could be stored as one or more text files, one or more JAVASCRIPT Object Notation (JSON) files, or in any other suitable format. The classification information may include one or more ratings, scores, textual labels, and/or any other suitable types of indicators.

Some or all of access points 104 may include a local cache 116. In the illustrated example, access point 104a includes local cache 116a, access point 104b includes local cache 116b, and access point 104c includes local cache 116c. Access points 104 may store certain network traffic classification information as classification information 114 in a local cache 116. In certain implementations, local cache 116 might be a limited resource such that local cache 116 might have a limited capability to store much if not most of the classification information (e.g., as classification information 114) for the network traffic 112 that might be generated by client devices 102. As described in greater detail below, depending on the scenario and implementation, an access point 104 may obtain classification information from the local cache 116 of the access point 104, from network management system 106, and/or from network traffic classification service 108.

Access points 104 may be located at one facility or may span multiple facilities, and may be located at one general geographic location or may span multiple geographic locations. Some or all of access points 104 may be dispersed throughout a physical environment (e.g., throughout a facility or campus) to provide connectivity to client devices 102 as those client devices 102 move throughout the physical environment. The physical environment in which access points 104 are dispersed, if applicable, may be one or multiple geographic locations, potentially spanning a large area and potentially including multiple geographic regions that are physically remote from each other (e.g., different buildings and/or sites). Access points 104 may be spaced apart in two or more dimensions. For example, access points 104 may be dispersed throughout a business facility to provide client devices 102 with network access to other client devices 102 and/or to other communication networks (e.g., to the Internet).

In certain implementations, access points 104 may belong to different customers (e.g. tenants), which may be designated using a customer identifier (CID). In the illustrated example, access points 104a and 104b belong to CID 1 and access point 104c belongs to CID 2. Of course, system 100 may include more or fewer (including no) customer subdivisions.

Network management system 106 may be configured to manage one or more communication networks. For example, network management system 106 may manage electronic devices connected to a communication network. Among other operations, whether for network security or for other purposes, the network management system 106 may detect and monitor electronic devices that are coupled to the communication network or otherwise detectable by other electronic devices in the communication network.

In certain implementations, network management system 106 may be configured to manage one or more access points 104. In the illustrated example, network management system 106 manages multiple access points 104 (access points 104a, 104b, and 104c). For example, network management system 106 may provide network traffic policies to access points 104 that access points 104 are to apply to network traffic 112. As a particular example, a user may interact with network management system 106 to define network traffic policies, and network management system 106 may distribute those policies to access points 104 for enforcement of the network policies on network traffic 112.

In certain implementations, network management system 106 may facilitate obtaining classification information for network traffic 112 and transmitting classification information to access points 104. Network management system 106 may include a local cache, which will be referred to as centralized cache 118. Network management system 106 may store certain network traffic classification information as classification information 120 in centralized cache 118. As will be described in greater detail below, access points 104 may request classification information from network management system 106, and network management system 106 may provide the requested classification information to the requesting access point 104. The centralized cache 118 of network management system 106 may be referred to as “centralized” because classification information 120 stored in centralized cache 118 may include classification information that network management system 106 obtained on behalf of or from multiple access points 104 and that may be available for network management system 106 to provide to access points 104. In certain implementations, centralized cache 118 might be a limited resource such that centralized cache 118 might have a limited capability to store all of the classification information (e.g., as classification information 120) that might be requested by access points 104. As described in greater detail below, depending on the scenario and implementation, network management system 106 may obtain classification information 120 from centralized cache 118, network traffic classification service 108, and/or access point 104.

Although a single network management system 106 is illustrated, system 100 may include any suitable number of network management systems 106. Additionally, network management system 106 may be located at the same or different physical/geographical location as one or more of access points 104. As one example, at least some of access points 104 may be located at an enterprise site, and network management system 106 might or might not be located at the enterprise site. For example, network management system 106 might or might not be deployed on-premises within a customer environment.

Network traffic classification service 108 may be a service that provides network classification information for network traffic (e.g., network traffic 112). Although not limited to such implementations, network traffic classification service 108 may be a third-party service that provide classification information for network traffic, possibly for a fee. Network traffic classification service 108 may be a third-party service in that the service is provided by an entity other than the provider of network management services associated with network management system 106 and a customer of the provider of network management services associated with network management system 106 (though, of course, the third-party also could be a provider of network management services associated with network management system 106 or a customer of the provider of network management services associated with network management system 106, if appropriate). Particular examples of network traffic classification service 108 may be provided by vendors such as BRIGHTCLOUD, QOSMOS, IPOQUE, O-DPI, IMPERVIA, VIRTELA TECHNOLOGY SERVICES, ZHILABS, and/or others. Although a single network traffic classification service 108 is illustrated, system 100 may include any suitable number of network classification services 108.

Network traffic classification service 108 may include storage device 122. Network traffic classification service 108 may store certain network traffic classification information as classification information 124 in storage device 122. As will be described in greater detail below, network management system 106 and/or access points 104 may request classification information from network traffic classification service 108, and network traffic classification service 108 may provide the requested classification information to network management system 106 and/or the requesting access point 104. In certain implementations, relative to local caches 116 of access points 104 and centralized cache 118 of network management system 106, classification information 124 of storage device 122 of network traffic classification service 108 may include a more comprehensive collection of classification information that is maintained and updated by an entity associated with network traffic classification service 108.

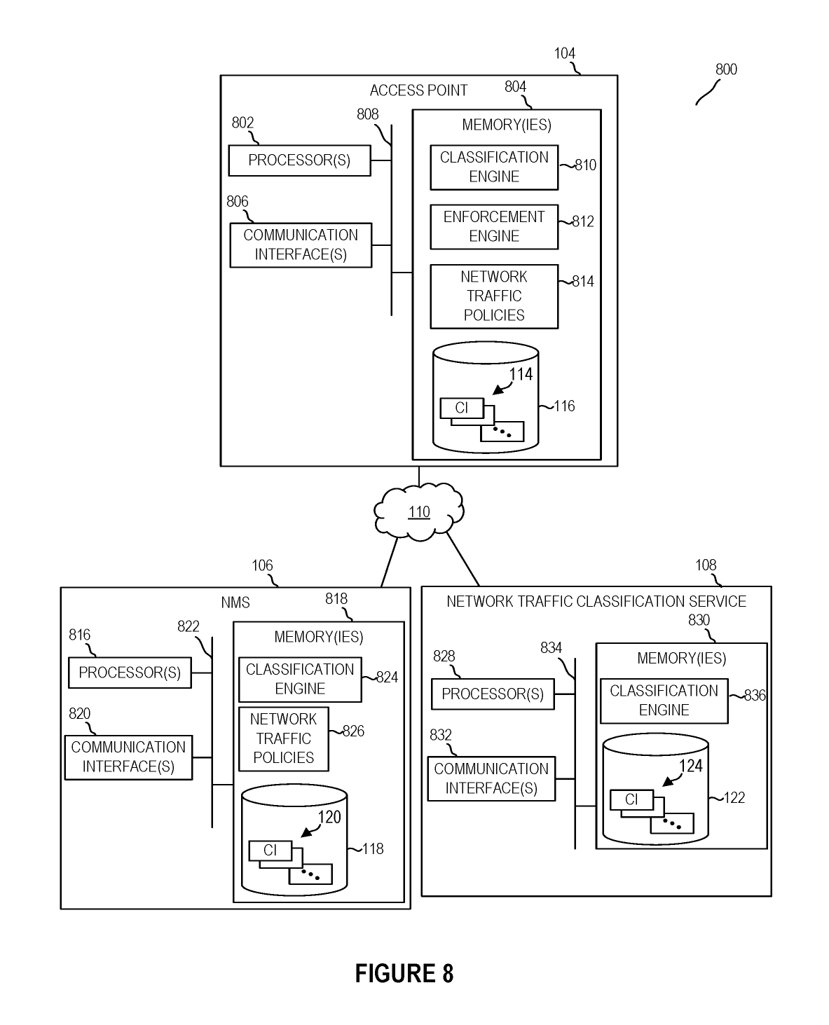

Client devices 102, access points 104, network management system 106, and network traffic classification service 108 may be implemented using any suitable combination of hardware, firmware, and software. Additional details of example implementations of access points 104, network management system 106 and network traffic classification service 108 are described in greater detail below with reference to FIG. 8.

Continuing with FIGS. 1A and 1B, local caches 116, centralized cache 118, and storage device 122 each may include any suitable combination of volatile memory, non-volatile memory, and/or virtualizations thereof. For example, memory may include any suitable combination of magnetic media, optical media, random access memory (RAM), read-only memory (ROM), removable media, and/or any other suitable memory device. Local caches 116, centralized cache 118, and storage device 122 may include data structures used to organize and store all or a portion of the stored data (e.g., classification information 114, 120, 124).

Additionally, classification information 114, classification information 120, and classification information 124 may be stored and/or organized in such a way that it can be searched according to some or all of the metadata that might be extracted or otherwise determined from network traffic 112. This may allow the applicable entity (e.g., access point 104, network management system 106, or network traffic classification service 108) to determine whether their respective classification information (e.g., classification information 114, classification information 120, and classification information 124, respectively) includes classification information for the network traffic 112 being classified. As just one example, metadata for particular types of network traffic 112 may include a URL, and where appropriate, certain classification information 114, classification information 120, and classification information 124 may be searchable according to a URL.

In certain implementations, local caches 116, centralized cache 118, and storage device 122 may include different storage capacities allocated for storing classification information 114, 120, and 124, respectively. For example, storage device 122 may have a greater storage capacity allocated for storing classification information than centralized cache 118, and centralized cache 118 may have a greater storage capacity for storing classification information than local cache 116. As a result, local cache 116a may store a smaller amount of classification information 114 relative to the amount of classification information 120 stored by centralized cache 118, and centralized cache 118 may store a smaller amount of classification information 120 relative to the amount of classification information 124 stored by storage device 122. Of course, this disclosure contemplates other implementations.

Given the relatively smaller storage capacity for classification information of local cache 116, the contents of local cache 116 may change on a relatively frequent basis according to any suitable caching policy such as time of addition of particular classification information 114 to local cache 116, frequency of use of particular classification information 114, and/or according to any other suitable policy. In certain implementations, centralized cache 118 might or might not be a limited resource for classification information 120, and might or might not also be subject to change on a relatively frequent basis as compared to storage device 122 according to an applicable caching policy.

The components of system 100 may communicate via communication network 110. Communication network 110 may facilitate wireless and/or or wired communication. Communication network 110 may communicate, for example, IP packets, Frame Relay frames, ATM cells, voice, video, data, and other suitable information between network addresses. Communication network 110 may include any suitable combination of one or more local area networks (LANs), radio access networks (RANs), metropolitan area networks (MANs), wide area networks (WANs), mobile networks (e.g., using WiMax (802.16), WiFi (802.11), 3G, 4G, 5G, or any other suitable wireless technologies in any suitable combination), all or a portion of the global computer network known as the Internet, and/or any other communication system or systems at one or more locations, any of which may be any suitable combination of wireless and wired. Communication network 110 may include controllers, access points, switches, routers, or the like for forwarding traffic between the components of system 100 and/or to other devices/networks.

Turning to FIG. 1A, FIG. 1A illustrates an example implementation in which network management system 106 serves as the primary interface with network traffic classification service 108 for purposes of obtaining classification information for network traffic (e.g., network traffic 112). In other words, network management system 106 may be the component primarily responsible for obtaining classification information from network traffic classification service 108 when classification information for particular network traffic 112 is not available in local cache 116 of a requesting access point 104 or in centralized cache 118 of network management system 106. Once retrieved from network traffic classification service 108, network management system 106 may communicate the obtained classification information for the particular network traffic 112 to the requesting access point 104.

In this example, network management system 106 manages multiple access points 104, and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is provided to access point 104a. Although described with reference to client device 102a, access point 104a, and network traffic 112a, other access points 104 (e.g., access points 104b and 104c) may operate similarly when processing network traffic 112 from client devices 102.

In operation of an example implementation, access point 104a may receive network traffic 112a and may determine whether classification information 114a in local cache 116a includes classification information for network traffic 112a. In certain implementations, access point 104a may extract or otherwise determine metadata from network traffic 112a and may use this metadata to search classification information 114a for classification information applicable to network traffic 112a. As just one example, the metadata for network traffic 112a may include a URL for a web site or other content associated with network traffic 112a, and access point 104a may search classification information 114a for classification data associated with that URL.

If access point 104a determines that classification information 114a in local cache 116a includes classification information for network traffic 112a, then access point 104a can process network traffic 112a using the classification information determined from classification information 114a in local cache 116a. For example, access point 104a may enforce one or more network policies on network traffic 112a according to the classification information determined for network traffic 112a from classification information 114a in local cache 116a.

If access point 104a determines that classification information 114a in local cache 116a does not include classification information for network traffic 112a, then access point 104a may transmit a classification request 126 to network management system 106 to attempt to obtain classification information for network traffic 112a. Classification request 126 may include some or all of the metadata that access point 104a extracted or otherwise determined from network traffic 112a.

Network management system 106 may receive classification request 126 and determine whether classification information 120 in centralized cache 118 includes classification information for network traffic 112a. In certain implementations, network management system 106 may extract or otherwise determine metadata for network traffic 112a from classification request 126 and may use this metadata to search classification information 120 for classification information applicable to network traffic 112a.

If network management system 106 determines that classification information 120 in centralized cache 118 includes classification information for network traffic 112a, then network management system 106 may obtain the classification for network traffic 112a from classification information 120 and transmit the classification information for network traffic 112a to the requesting access point 104 (e.g., access point 104a) as classification response 128. For example, network management system 106 may retrieve a copy of the classification information for network traffic 112a from classification information 120 of centralized cache 118, and include that classification information in a classification response transmitted by network management system 106 to access point 104a. In certain implementations, access point 104a may store the classification information from classification response 128 in local cache 116a as part of classification information 114a so that the classification information for network traffic 112a might be available locally to access point 104a for at least some period of time in the future. Access point 104a can then process network traffic 112a using the classification information received from network management system 106 as part of classification response 128.

If network management system 106 determines that classification information 120 in centralized cache 118 does not include classification information for network traffic 112a, then network management system 106 may transmit a classification request 130 to network traffic classification service 108 to attempt to obtain classification information for network traffic 112a from network traffic classification service 108. Classification request 130 may include some or all of the metadata (e.g., for network traffic 112a) that network management system 106 received as part of classification request 126 for network traffic 112a. In certain implementations, system 100 may include multiple network traffic classification services 108, and network management system 106 may transmit classification requests 130 to some or all of those network traffic classification services 108 to attempt to obtain classification information for network traffic 112a.

Network traffic classification service 108 may receive classification request 130 and may retrieve the classification information for network traffic 112a from classification information 124 in storage device 122. In certain implementations, network traffic classification service 108 may extract or otherwise determine metadata for network traffic 112a from classification request 130 and may use this metadata to retrieve the classification information for network traffic 112a from classification information 124. Network traffic classification service 108 may transmit the classification information for network traffic 112a (retrieved from classification information 124) to network management system 106 as classification response 132.

Network management system 106 may receive classification response 132 that includes classification information for network traffic 112a. In certain implementations, network management system 106 may store the classification information from classification response 132 in centralized cache 118 as part of classification information 120 so that the classification information for network traffic 112a might be available locally to network management system 106 for at least some period of time in the future to provide to requesting access points 104, thereby reducing or eliminating future requests to network traffic classification service 108 for the classification information for network traffic 112a.

In response to receiving classification response 132 that includes classification information for network traffic 112a, network management system 106 may transmit the classification information for network traffic 112a to access point 104a as part of classification response 128. In certain implementations, access point 104a may store the classification information from classification response 128 in local cache 116a as part of classification information 114a so that the classification information for network traffic 112a might be available locally to access point 104a for at least some period of time in the future. Access point 104a can then process network traffic 112a using the classification information received from network management system 106 as part of classification response 128.

In certain implementations, network traffic classification service 108 may transmit a classification information update 134 to network management system 106. Over time, classification information 124 for network traffic 112 may change, whether due to modifications to existing classification information, deletions of particular classification information, additions of new classification information, or for any other suitable reason. Classification information update 134 may include transmitting some or all of the current classification information 124 to network management system 106, so that network management system 106 may update classification information 120 in centralized cache 118. The classification information of classification information update 134 may be filtered (e.g., by network traffic classification service 108 and/or network management system 106) in any suitable manner. Network traffic classification service 108 may transmit classification information updates 134 at any suitable regular or irregular intervals, in response to a request from network management system 106, and/or in response to any other suitable trigger. In certain implementations, network traffic classification service 108 might not transmit classification information updates 134.

In certain implementations, network management system 106 may transmit a classification information update 136 to one or more of access points 104. Over time, classification information 120 for network traffic 112 may change, whether due to modifications to classification information updates 134 from network traffic classification service 108, retrieval of classification information for network traffic 112 from network traffic classification service 108 in response to classification requests 126 from access points 104 (e.g., and associated storing of that retrieved classification information in classification information 120 of centralized cache 118), or for any other suitable reason. Classification information update 136 may include transmitting some or all of the current classification information 120 to some or all of access points 104, so that access points 104 may update the classification information in their respective local caches 116. The classification information of classification information update 136 may be filtered (e.g., by network management system 106 and/or access points) in any suitable manner. Network management system 106 may transmit classification information updates 136 at any suitable regular or irregular intervals, in response to a request from an access point 104, and/or in response to any other suitable trigger.

Although operation of system 100 in FIG. 1A was described with reference to network traffic 112 for a client device 102a communicating with access point 104a, over time network management system 106 may be performing similar operations with respect to the same or different client devices 102, the same or different access points 104, and the same or different network traffic 112 (for classification purposes). Over time, network management system 106 may amass classification information 120 in centralized cache 118 that might be useful for satisfying classification requests (e.g., similar to classification requests 126) from access points 104.

For example, assume client device 102a roams to a second access point 104b and generates network traffic 112a', which for purposes of this example will be assumed to be the same network traffic as network traffic 112a (e.g., accessing the same or similar content). When access point 104b requests classification information for network traffic 112a' from network management system 106, network management system 106 may have a copy of the relevant classification information stored in centralized cache 118 due to previously obtaining the classification information when access point 104a requested the classification information for network traffic 112a.

As another example, assume a second client device 102b generates at a second access point 104b network traffic 112b, which for purposes of this example will be assumed to be the same network traffic as network traffic 112a (e.g., accessing the same or similar content), When access point 104b requests classification information for network traffic 112b from network management system 106, network management system 106 may have a copy of the relevant classification information stored in centralized cache 118 due to previously obtaining the classification information when access point 104a requested the classification information for network traffic 112a.

As another example, assume a third client device 102c generates at a third access point 104c network traffic 112c, which for purposes of this example will be assumed to be the same network traffic as network traffic 112a (e.g., accessing the same or similar content), and also assume that the client device 102a and access point 104a are associated with a first customer identifier (CID1) and that client device 102c and access point 102c are associated with a second customer identifier (CID2). Continuing with this example, when access point 104c requests classification information for network traffic 112c from network management system 106, network management system 106 may have a copy of the relevant classification information stored in centralized cache 118 due to previously obtaining the classification information when access point 104a requested the classification information for network traffic 112a. Thus, because centralized cache 118 may store classification for different customer environments/CIDs, network management system still may be able to more efficiently provide network classification information for network traffic 112 associated with client devices 102/access points 104 for different customer environments/CIDs.

Because the classification requests for classification information from network traffic classification service 108 (whether originating from access points 104 or network management system 106) are handled by network management system 106, these classification requests may provide a relatively secure way to obtain classification information, particularly given the relatively secure connection that might be employed between network management system 106 and access points 104.

Turning to FIG. 1B, FIG. 1B illustrates an example implementation in which network management system 106 serves as an initial cache check point for an access point 104 to request classification information applicable to particular network traffic 112, but in which the requesting access point 104 may attempt to obtain applicable classification from network traffic classification service 108 if unavailable at network management system 106. In other words, access points 104 may be the components primarily responsible for obtaining classification information from network traffic classification service 108 when classification information for particular network traffic 112 is not available in local cache 116 of a requesting access point 104 or in centralized cache 118 of network management system 106. Once retrieved from network traffic classification service 108, the requesting access point 104 may communicate the obtained classification information for the particular network traffic 112 to network management system 106 so that network management system 106 can update classification information 120 in centralized cache 118, potentially expediting future requests for classification information for similar network traffic 112.

In this example, network management system 106 manages multiple access points 104, and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is provided to access point 104a. Although described with reference to client device 102a, access point 104a, and network traffic 112a, other access points 104 (e.g., access points 104b and 104c) may operate similarly when processing network traffic 112 from client devices 102.

In operation of an example implementation, operation of system 100 may be similar to operation of system 100 described above with reference to FIG. 1A up to the point of network management system 106 receiving classification request 126 and determining whether classification information 120 in centralized cache 118 includes classification information for network traffic 112a. Even following receipt of classification request 126 and determination of whether classification information 120 in centralized cache 118 includes classification information for network traffic 112a, if network management system 106 determines that classification information 120 in centralized cache 118 includes classification information for network traffic 112a, then network management system 106 may proceed similarly to the operation described with reference to FIG. 1A, including by obtain the classification for network traffic 112a from classification information 120 and transmit the classification information for network traffic 112a to the requesting access point 104 (e.g., access point 104a) as classification response 128.

Continuing with FIG. 1B, if network management system 106 determines that classification information 120 in centralized cache 118 does not include classification information for network traffic 112a, then network management system 106 may transmit a classification response 128 that includes a null response. A null response may indicate (whether explicitly, by the formatting/type of the message, or otherwise) that network management system 106 lacks classification information for network traffic 112a.

Access point 104a may receive the classification response 128 including the null response, and in response to this null response, may transmit a classification request 138 (e.g., directly) to network traffic classification service 108 to attempt to obtain classification information for network traffic 112a from network traffic classification service 108. Classification request 138 may include some or all of the metadata (e.g., for network traffic 112a) that access point 104a extracted or otherwise determined from network traffic 112a and included as part of classification request 126. In certain implementations, system 100 may include multiple network traffic classification services 108, and access point 104a may transmit classification requests 138 to some or all of those network traffic classification services 108 to attempt to obtain classification information for network traffic 112a.

Network traffic classification service 108 may receive classification request 138 and may retrieve the classification information for network traffic 112a from classification information 124 in storage device 122. In certain implementations, network traffic classification service 108 may extract or otherwise determine metadata for network traffic 112a from classification request 138 and may use this metadata to retrieve the classification information for network traffic 112a from classification information 124. Network traffic classification service 108 may transmit the classification information for network traffic 112a (retrieved from classification information 124) to access point 104a as classification response 140.

Access point 104a may receive classification response 140 that includes classification information for network traffic 112a. In certain implementations, access point 104a may store the classification information from classification response 140 in local cache 116a as part of classification information 114a so that the classification information for network traffic 112a might be available locally to access point 104a for at least some period of time in the future, thereby reducing or eliminating future requests to network management system 106 and/or network traffic classification service 108 for the classification information for network traffic 112a. Access point 104a can then process network traffic 112a using the classification information received from network traffic classification service 108 as part of classification response 140.

In certain implementations, in response to receiving classification response 140 that includes classification information for network traffic 112a, access point 104a may transmit the classification information for network traffic 112a to network management system 106 as part classification information update 142. Network management system 106 may receive classification information update 142 that includes classification information for network traffic 112a. Network management system 106 may store the classification information from classification information update 142 in centralized cache 118 as part of classification information 120 so that the classification information for network traffic 112a might be available locally to network management system 106 for at least some period of time in the future to provide to requesting access points 104, thereby reducing or eliminating future requests to network traffic classification service 108 for the classification information for network traffic 112a.

Continuing with FIG. 1B, as described above with reference to FIG. 1A, in certain implementations, network traffic classification service 108 may transmit a classification information update 134 to network management system 106. Additionally or alternatively, as described above with reference to FIG. 1A, in certain implementations, network management system 106 may transmit a classification information update 136 to one or more of access points 104.

Although operation of system 100 in FIG. 1B was described with reference to network traffic 112 for a client device 102a communicating with access point 104a, over time network management system 106 may be performing similar operations with respect to the same or different client devices 102, the same or different access points 104, and the same or different network traffic 112 (for classification purposes). That is, even though access points 104 may interact directly with network traffic classification service 108 to obtain classification information that is unavailable in local caches 114 and/or centralized cache 118, because access points 104 provide the obtained classification information to network management system 106 for storage in centralized cache 118, over time, network management system 106 may amass classification information 120 in centralized cache 118 that might be useful for satisfying classification requests (e.g., similar to classification requests 126) from access points 104.

For example, assume client device 102a roams to a second access point 104b and generates network traffic 112a', which for purposes of this example will be assumed to be the same network traffic as network traffic 112a (e.g., accessing the same or similar content). When access point 104b requests classification information for network traffic 112a' from network management system 106, network management system 106 may have a copy of the relevant classification information stored in centralized cache 118 due to previously obtaining the classification information when access point 104a requested the classification information for network traffic 112a.

As another example, assume a second client device 102b generates at a second access point 104b network traffic 112b, which for purposes of this example will be assumed to be the same network traffic as network traffic 112a (e.g., accessing the same or similar content), When access point 104b requests classification information for network traffic 112b from network management system 106, network management system 106 may have a copy of the relevant classification information stored in centralized cache 118 due to previously obtaining the classification information when access point 104a requested the classification information for network traffic 112a.

As another example, assume a third client device 102c generates at a third access point 104c network traffic 112c, which for purposes of this example will be assumed to be the same network traffic as network traffic 112a (e.g., accessing the same or similar content), and also assume that the client device 102a and access point 104a are associated with a first customer identifier (CID1) and that client device 102c and access point 102c are associated with a second customer identifier (CID2). Continuing with this example, when access point 104c requests classification information for network traffic 112c from network management system 106, network management system 106 may have a copy of the relevant classification information stored in centralized cache 118 due to previously obtaining the classification information when access point 104a requested the classification information for network traffic 112a. Thus, because centralized cache 118 may store classification for different customer environments/CIDs, network management system still may be able to more efficiently provide network classification information for network traffic 112 associated with client devices 102/access points 104 for different customer environments/CIDs.

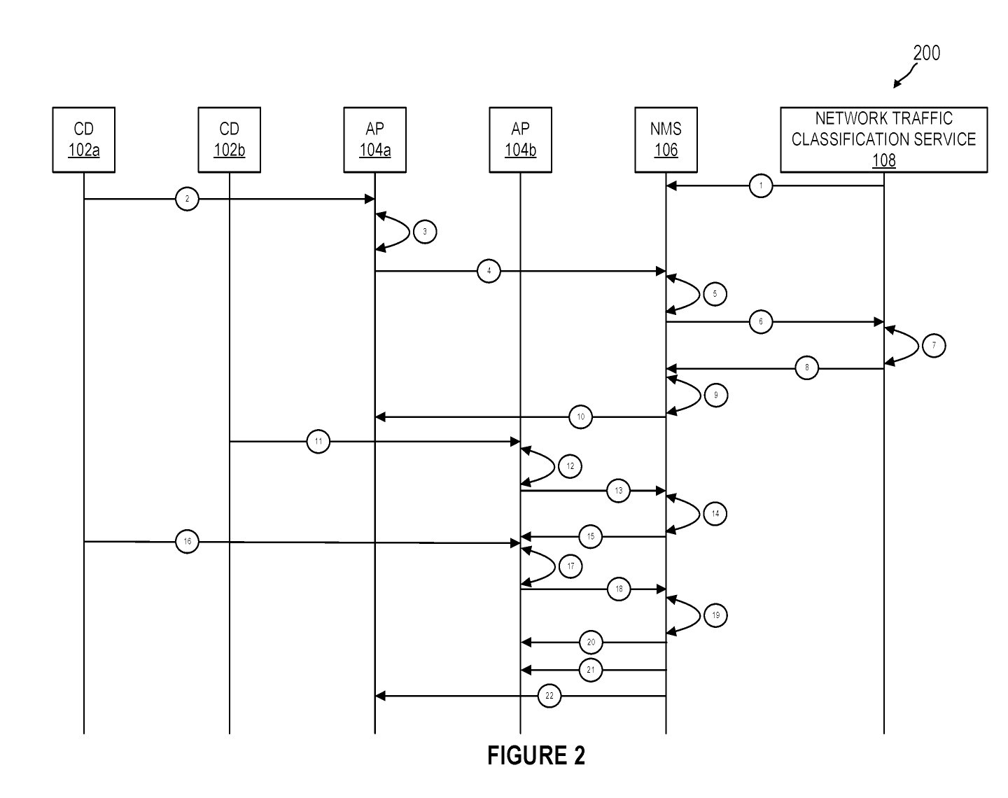

FIG. 2 illustrates an example signaling flow 200 for classification of network traffic using a centralized cache of network information, according to certain implementations. In certain implementations, signaling flow 200 may correspond to the operations described above with reference to FIG. 1A, and throughout the description of signaling flow 200, reference may be made to items appearing in FIG. 1A for example purposes. In the illustrated example, signaling flow 200 involves communication between/among access client devices 102a and 102b (abbreviated as CD 102a and CD 102b, respectively), access points 104a and 104b (abbreviated as AP 104a and AP 104b, respectively), network management system 106 (abbreviated as NMS 106), and network traffic classification service 108. Furthermore, communication between entities of system 100 may occur over network 110. The following describes steps 1 through 22 of the example signaling flow 200 of FIG. 2.

As with the example of FIG. 1A, in this example signaling flow 200, network management system 106 manages multiple access points 104 (e.g. at least access points 104a and 104b), and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is provided to access point 104a. Although described with reference to client device 102a, client device 102b, access point 104a, access point 104b, and network traffic 112a, other access points 104 (e.g., access point 104c) may operate similarly when processing network traffic 112 from client devices 102.

At step 1, network traffic classification service 108 may transmit a classification information update 134 to network management system 106. Network management system 106 may receive the classification information update 134 from network traffic classification service 108, and may initially store or update classification information 120 in centralized cache 118. Although shown at the beginning of signaling flow 200, step 1 could be performed repeatedly throughout signaling flow 200, at any suitable regular or irregular interval, or potentially not be performed at all.

At step 2, client device 102a may connect to or may already be connected to access point 104a and may transmit network traffic 112a to access point 104a. Access point 104a may receive network traffic 112a, and at step 3, may determine (e.g., using metadata of network traffic 112a) whether classification information 114a in local cache 116a includes classification information for network traffic 112a.

If access point 104a determines that classification information 114a in local cache 116a includes classification information for network traffic 112a, then access point 104a can process network traffic 112a using the classification information determined from classification information 114a in local cache 116a. The particular action taken by access point 104a would depend on the particular implementation and associated traffic policies being applied by access point 104a. If, on other hand, access point 104a determines that classification information 114a in local cache 116a does not include classification information for network traffic 112a, then access point 104a may transmit, at step 4, a classification request 126 to network management system 106 to attempt to obtain classification information for network traffic 112a.

Network management system 106 may receive classification request 126 and, at step 5, may determine whether classification information 120 in centralized cache 118 includes classification information for network traffic 112a. If network management system 106 determines at step 5 that classification information 120 in centralized cache 118 includes classification information for network traffic 112a, then signaling flow 200 may proceed to step 10.

If network management system 106 determines at step 5 that classification information 120 in centralized cache 118 does not include classification information for network traffic 112a, then at steps 6-8, network management system 106 may obtain network information for network traffic 112a from network traffic classification service 108. For example, at step 6, network management system 106 may transmit a classification request 130 to network traffic classification service 108 to attempt to obtain classification information for network traffic 112a from network traffic classification service 108. In certain implementations, system 100 may include multiple network traffic classification services 108, and network management system 106 may transmit classification requests 130 to some or all of those network traffic classification services 108 to attempt to obtain classification information for network traffic 112a.

At step 7, network traffic classification service 108 may receive classification request 130 and may retrieve the classification information for network traffic 112a from classification information 124 in storage device 122. At step 8, network traffic classification service 108 may transmit the classification information for network traffic 112a (retrieved from classification information 124) to network management system 106 as classification response 132. At step 9, network management system 106 may receive classification response 132 that includes classification information for network traffic 112a, and may store the classification information from classification response 132 in centralized cache 118 as part of classification information 120.

At step 10, whether obtained from centralized cache 118 at step 5 or from classification response 132 at steps 6-8, network management system 106 may transmit the classification information for network traffic 112a to the requesting access point 104 (e.g., access point 104a) as classification response 128. Access point 104a may receive and store the classification information from classification response 128 in local cache 116a as part of classification information 114a. Access point 104a can then process network traffic 112a using the classification information received from network management system 106 as part of classification response 128. The particular action performed by access point 104a would depend on the particular implementation and associated traffic policies being applied by access point 104a.

Steps 11 through 22 of signaling flow 200 illustrate example subsequent network traffic 112 and how that network traffic might be classified in view of the prior classification of network traffic 112. At step 11, client device 102b may connect to or may already be connected to access point 104b and may transmit network traffic 112b to access point 104b. Access point 104b may receive network traffic 112b, and at step 12, may determine (e.g., using metadata of network traffic 112b) whether classification information 114b in local cache 116b includes classification information for network traffic 112b. For purposes of this example, it will be assumed that network traffic 112b is the same as network traffic 112a for traffic classification purposes. In this example, it will be assumed that access point 104b determines that classification information 114b in local cache 116b does not include classification information for network traffic 112b. In response to that determination, access point 104b may attempt to obtain classification information for network traffic 112b from network management system 106. For example, access point 104b may transmit, at step 13, a classification request (e.g., similar to classification request 126) to network management system 106 to attempt to obtain classification information for network traffic 112b.

Network management system 106 may receive the classification request sent by access point 104b and, at step 14, may determine whether classification information 120 in centralized cache 118 includes classification information for network traffic 112b. In this example, at least because network traffic 112b is the same as network traffic 112a for traffic classification purposes and network management system 106 previously obtained classification information for network traffic 112b and stored that classification information in classification information 120 of centralized cache 118, network management system 106 may determine that classification information 120 in centralized cache 118 includes classification information for network traffic 112b. As a result, network management system 106 may avoid communicating with network traffic classification service 108 to obtain classification information for network traffic 112b. It should be noted that, in some scenarios, depending on the retention policies for centralized cache 118, it might not be the case that classification information 120 would include classification information for network traffic 112a/112b forever. Nonetheless, this centralized approach of collecting and storing classification information for network traffic 112 may reduce or eliminate certain communication with network traffic classification service 108 for obtaining classification information for network traffic 112.

Thus, in this example, network management system 106 determines at step 14 that classification information 120 in centralized cache 118 includes classification information for network traffic 112b, and signaling flow 200 may proceed to step 15. At step 15, network management system 106 may transmit the classification information for network traffic 112b to access point 104b as a classification response (e.g., similar to classification response 128). Access point 104b may receive and store the classification information from the classification response in local cache 116b as part of classification information 114b. Access point 104b can then process network traffic 112b using the classification information received from network management system 106 as part of the classification response. The particular action performed by access point 104b would depend on the particular implementation and associated traffic policies being applied by access point 104b.

At step 16, client device 102a may connect to or may already be connected to access point 104b and may transmit network traffic 112a' to access point 104b. For example, client device 102a may move (or be moved) within an area such that client device 102a roams from access point 104a to access point 104b, but in this example, client device 102a still is sending network traffic 112a (identified as network traffic 112a' for ease of reference) to access point 104b. for purposes of this example, it will be assumed that network traffic 112a' is the same as network traffic 112a for traffic classification purposes.

Access point 104b may receive network traffic 112a', and at step 17, may determine (e.g., using metadata of network traffic 112a') whether classification information 114b in local cache 116b includes classification information for network traffic 112b. If access point 104b determines that classification information 114b in local cache 116b includes classification information for network traffic 112a', then access point 104b can process network traffic 112a' using the classification information determined from classification information 114b in local cache 116b. The particular action taken by access point 104b would depend on the particular implementation and associated traffic policies being applied by access point 104b. If, on other hand, access point 104b determines that classification information 114b in local cache 116b does not include classification information for network traffic 112a', then access point 104b may transmit a classification request (e.g., similar to classification request 126) to network management system 106 to attempt to obtain classification information for network traffic 112a'.

In the illustrated example, access point 104b determines that classification information 114b in local cache 116b does not include classification information for network traffic 112a'. In response to that determination, access point 104b may attempt to obtain classification information for network traffic 112a' from network management system 106. For example, access point 104b may transmit, at step 18, a classification request (e.g., similar to classification request 126) to network management system 106 to attempt to obtain classification information for network traffic 112a'.

Network management system 106 may receive the classification request sent by access point 104b and, at step 19, may determine whether classification information 120 in centralized cache 118 includes classification information for network traffic 112a'. In this example, at least because network traffic 112a' is the same as network traffic 112a for traffic classification purposes and network management system 106 previously obtained classification information for network traffic 112a and stored that classification information in classification information 120 of centralized cache 118, network management system 106 may determine that classification information 120 in centralized cache 118 includes classification information for network traffic 112a'. As a result, network management system 106 may avoid communicating with network traffic classification service 108 to obtain classification information for network traffic 112a'. Again, it should be noted that, in some scenarios, depending on the retention policies for centralized cache 118, it might not be the case that classification information 120 would include classification information for network traffic 112a/112a' forever. Nonetheless, this centralized approach of collecting and storing classification information for network traffic 112 may reduce or eliminate certain communication with network traffic classification service 108 for obtaining classification information for network traffic 112.

Thus, in this example, network management system 106 determines at step 19 that classification information 120 in centralized cache 118 includes classification information for network traffic 112a', and signaling flow 200 may proceed to step 20. At step 20, network management system 106 may transmit the classification information for network traffic 112a' to access point 104b as a classification response (e.g., similar to classification response 128). Access point 104b may receive and store the classification information from the classification response in local cache 116b as part of classification information 114b. Access point 104b can then process network traffic 112b using the classification information received from network management system 106 as part of the classification response. The particular action performed by access point 104b would depend on the particular implementation and associated traffic policies being applied by access point 104b.

Although signaling flow 200 has been described in an example in which access point 104b determines at step 17 that local cache 116b does not include classification information for network traffic 112a', other scenarios are possible. For example, in signaling flow 200, at step 15 network management system 106 transmitted classification information for network traffic 112b to access point 104b. In certain implementations, access point 104b may have stored the classification information for network traffic 112b as part of classification information 114b of local cache 116b. Given the assumption that network traffic 112b is the same as network traffic 112a for traffic classification purposes, coupled with the assumption that network traffic 112a' is the same as network traffic 112a for traffic classification purposes, classification information 114b of local cache 116b might include classification information for network traffic 112a'. In such an example, and assuming that classification information for network traffic 112a/112b/112a' remains in local cache 116b according to cache retention policies, access point 104b may determine at step 17 that classification information 114b in local cache 116b includes the classification information for network traffic 112a'. Continuing with this example, access point 104b can then process network traffic 112a' using the classification information 114b in local cache 116b without (again) obtaining classification information for network traffic 112a' from network management system 106 (e.g., thereby skipping steps 18, 19, and 20 of signaling flow 200).

At steps 21 and 22, network management system 106 may transmit a classification information update 136 to access point 104b and access point 104a, respectively. The illustrated order of steps 21 and 22 is arbitrary and could be reversed, or steps 21 and 22 could be performed at least partially simultaneously, if appropriate.

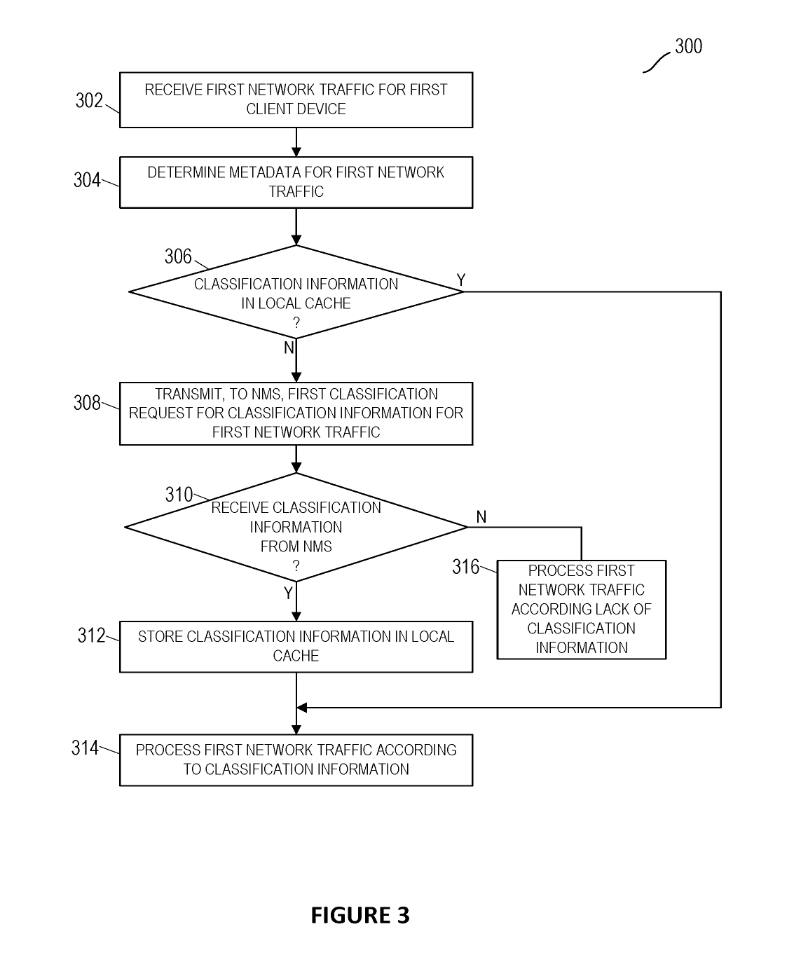

FIG. 3 illustrates an example method 300 for classification of network traffic using a centralized cache of network information, according to certain implementations. In certain implementations, method 300 may correspond to certain operations described above with reference to FIG. 1A and signaling flow 200 of FIG. 2. Reference may be made to items appearing in FIG. 1A for example purposes. In certain implementations, some or all of the steps described with reference to method 300 may be performed by an access point 104, which for purposes of this example will be described as access point 104a.

As with the example of FIGS. 1A and 2, in this example method 300, network management system 106 manages multiple access points 104 (e.g. at least access points 104a and 104b), and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is received by access point 104a. Although described with reference to client device 102a, access point 104a, and network traffic 112a, other access points 104 (e.g., access points 104b and 104c) may operate similarly when processing network traffic 112 from client devices 102.

At step 302, access point 104a may receive network traffic 112a from client device 102a. For example, client device 102a may connect to or may already be connected to access point 104a and may transmit network traffic 112a to access point 104a. As particular examples, and as described above, client device 102a may generate network traffic 112a by accessing applications, websites, or other content, and that network traffic 112a may traverse access point 104a en route to a communication network (e.g., a portion of network 110).

At step 304, access point 104a may determine metadata for network traffic 112a. For example, access point 104a may extract or otherwise determine metadata from network traffic 112a. As described above, the metadata may include certain attributes of the network traffic 112 that may be used to identify the network traffic.

At step 306, access point 104a may determine whether classification information 114a in local cache 116a includes classification information for network traffic 112a. In other words, prior to engaging another entity (e.g., network management system 106 and/or network traffic classification service 108) to obtain classification information for network traffic 112a (e.g., by transmitting a classification request 126 to network management system 106 and/or a classification request 138 to network traffic classification service 108), access point 104a may access local cache 116a and determine whether classification information 114a in local cache 116a includes classification information for network traffic 112a.

As described above, classification information for network traffic 112 may provide a network traffic profile for network traffic 112 and may include traffic category information, traffic reputation information, and/or any other suitable information. In certain implementations, access point 104a may use some or all of the metadata determined from network traffic 112a at step 304 to search classification information 114a for classification information applicable to network traffic 112a. As just one example, the metadata for network traffic 112a may include a URL for a web site or other content associated with network traffic 112a, and access point 104a may search classification information 114a for classification data associated with that URL.

If access point 104a determines at step 306 that classification information 114a in local cache 116a includes classification information for network traffic 112a, then access point 104a may proceed to step 314, described below. If, on the other hand, access point 104a determines at step 306 that classification information 114a in local cache 116a does not include classification information for network traffic 112a, then at steps 308-312, access point 104a may attempt to obtain classification information for network traffic 112a from network management system 106.

At step 308, access point 104a may transmit a classification request 126 to network management system 106 to attempt to obtain classification information for network traffic 112a. Classification request 126 may include some or all of the metadata determined from network traffic 112a at step 304.

At step 310, access point 104a may determine whether classification information for network traffic 112a has been received from network management system 106. In certain implementations, access point 104a may make this determination based on a type of classification response 128 received from network management system 106 (e.g., in response to classification request 126). For example, classification response 128 may include classification information for network traffic 112a, and access point 104a may determine that classification information for network traffic 112a has been received based on this type of classification response 128. As another example, classification response 128 may be a null response, which may indicate (whether explicitly, by the formatting/type of the message, or otherwise) that network management system 106 lacks classification information for network traffic 112a, and access point 104a may determine that classification information for network traffic 112a has not been received based on this type of classification response 128. As another example, access point 104a may fail to receive, after a predetermine time, any response from network management system 106 in response to classification request 126, which access point 104a may treat as a classification response 128 that includes a null response, or may handle in any other suitable manner.

If access point 104a determines at step 310 that access point 104a has received classification information for network traffic 112a from network management system 106, then method 300 may proceed to step 312. At step 312, in response to receiving the classification information for network traffic 112a, access point 104a may store the classification information for network traffic 112a as part of classification information 114a in local cache 116a, so that access point 104a may have a quickly accessible local copy of classification information for network traffic 112a for at least some period of time in the future.

At step 314, access point 104a may process network traffic 112a using the obtained classification information for network traffic 112a. For example, if access point 104a was able to locate classification information for network traffic 112a in classification information 114a of local cache 116a (at step 306), then at step 314, access point 104a may retrieve the classification information for network traffic 112a from classification information 114a of local cache 116a, and may process network traffic 112a according to the classification information for network traffic 112a retrieved from classification information 114a of local cache 116a. As another example, if access point 104a obtains classification information for network traffic 112a from network management system 106 (e.g., via a classification response 128 received at step 310), then at step 314, access point 104a may access the classification information for network traffic 112a, and may process network traffic 112a according to the classification information for network traffic 112a received from network management system 106. For example, access point 104a may enforce one or more network policies on network traffic 112a according to the classification information for network traffic 112a.

Returning to step 310, if access point 104a determines at step 310 that classification information for network traffic 112a has not been received from network management system 106, then method 300 may proceed to step 316. At step 316, access point 104a may process network traffic 112a according to a lack of obtained classification information for network traffic 112a. For example, access point 104a may enforce one or more network policies on network traffic 112a according to the lack of obtained classification information for network traffic 112a. In certain implementations, this might include blocking network traffic 112a and/or proceeding in any other suitable manner.

In certain implementations, method 300 could include steps in which access point 104a receives, from network management system 106, a classification information update 136 that includes classification information obtained by network management system 106 from access point 104a, one or more access points 104 other than access point 104a, network traffic classification service 108, and/or any other suitable classification information source. Access point 104a may store some or all of the classification information included in the received classification information update 136 in local cache 116a.

In certain implementations, method 300 could continue and/or be repeatedly performed as access point 104a receives additional network traffic 112 from client device 102a and/or other client devices 102. The additional network traffic 112 might or might not be the same as network traffic 112a for traffic classification purposes. As just one example, method 300 may include access point 104a receiving additional network traffic 112 from client device 102a or another client device (e.g., client device 102b or client device 102c). Access point 104a may attempt to obtain classification information for the additional network traffic 112 from classification information 114a in local cache 116a. In response to determining that classification information 114a in local cache 116a does not include classification information for the additional network traffic 112, access point 104a may attempt to obtain the classification information for the additional network traffic 112 from network management system 106. For example, access point 104a may transmit, to network management system 106, a classification request (e.g., similar to classification request 126) for classification information for the additional network traffic 112, and may receive, from network management system 106, the classification information for the additional network traffic 112. In response to receiving the classification information for the additional network traffic 112, access point 104a may process the additional network traffic 112 according to the classification information for the additional network traffic 112.

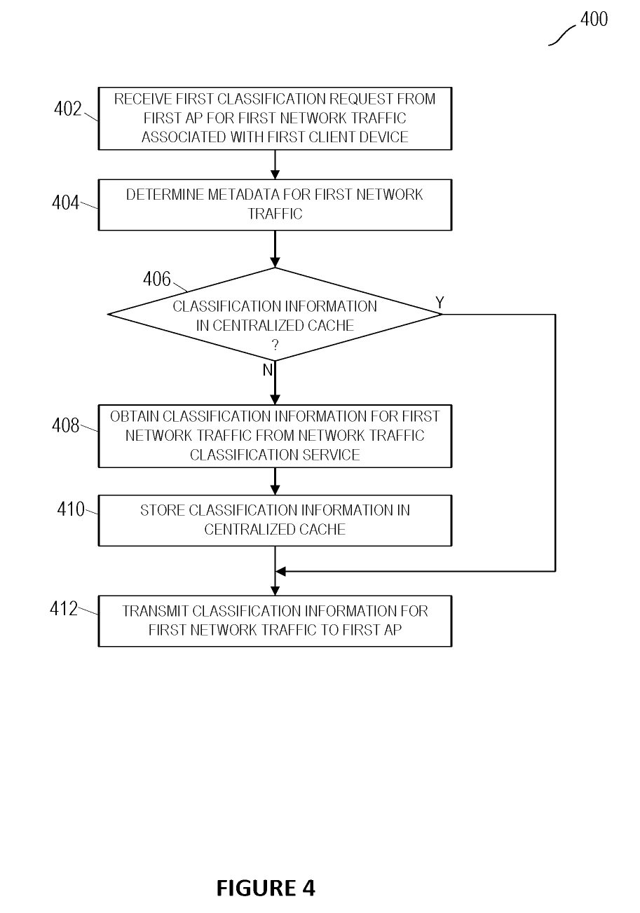

FIG. 4 illustrates an example method 400 for classification of network traffic using a centralized cache of network information, according to certain implementations. In certain implementations, method 400 may correspond to certain operations described above with reference to FIG. 1A and signaling flow 200 of FIG. 2. Reference may be made to items appearing in FIG. 1A for example purposes. In certain implementations, some or all of the steps described with reference to method 400 may be performed by network management system 106.

As with the example of FIGS. 1A and 2, in this example method 400, network management system 106 manages multiple access points 104 (e.g. at least access points 104a and 104b), and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is received by access point 104a, and for which access point 104a attempts to obtain classification information from network management system 106. Although described with reference to client device 102a, access point 104a, and network traffic 112a, network management system 106 may operate similarly when processing request for classification information for other network traffic 112 of access point 104a or network traffic 112 from other client devices 102.

At step 402, network management system 106 may receive a classification request 126 from access point 104a. Classification request 126 may request classification information for network traffic 112a, which may be associated with a client device 102a from which access point 104a received network traffic 112a. Classification request 126 may include some or all of the metadata that access point 104a extracted or otherwise determined from network traffic 112a, as described elsewhere in this disclosure.

At step 404, network management system 106 may determine the metadata for network traffic 112a. For example, network management system 106 may access classification request 126 and extract or otherwise determine some or all of the metadata for network traffic 112a from classification request 126.

At step 406, network management system 106 may determine whether classification information 120 in centralized cache 118 includes classification information for network traffic 112a. In certain implementations, network management system 106 may use the metadata determined at step 404 to search classification information 120 for classification information applicable to network traffic 112a. If network management system 106 determines at step 406 that classification information 120 in centralized cache 118 includes classification information for network traffic 112a, then method 400 may proceed to step 412, described below. If network management system 106 determines that classification information 120 in centralized cache 118 does not include classification information for network traffic 112a, then method 400 may proceed to step 408.

At step 408, network management system 106 may attempt to obtain classification information for network traffic 112a from network traffic classification service 108. For example, network management system 106 may transmit a classification request 130 to network traffic classification service 108 to attempt to obtain classification information for network traffic 112a from network traffic classification service 108. Classification request 130 may include some or all of the metadata (e.g., for network traffic 112a) that network management system 106 received as part of classification request 126 for network traffic 112a. Network management system 106 may receive from network traffic classification service 108 classification response 132 that includes classification information for network traffic 112a. At step 410, network management system 106 may store the classification information from classification response 132 in centralized cache 118 as part of classification information 120 so that the classification information for network traffic 112a might be available locally to network management system 106 for at least some period of time in the future to provide to requesting access points 104, thereby reducing or eliminating future requests to network traffic classification service 108 for the classification information for network traffic 112a.

At step 412, network management system 106 may transmit the obtained classification information for network traffic 112a to access point 104a as classification response 128. For example, if network management system 106 was able to locate classification information for network traffic 112a in classification information 120 of centralized cache 118 (at step 406), then at step 412, network management system 106 may retrieve a copy of the classification information for network traffic 112a from classification information 120 of centralized cache 118, and may include that classification information in a classification response transmitted by network management system 106 to access point 104a. As another example, if network management system 106 obtains classification information for network traffic 112a from network traffic classification service 108 (e.g., via a classification response 132 received at step 408), then at step 412, in response to receiving classification response 132 that includes classification information for network traffic 112a, network management system 106 may transmit the classification information for network traffic 112a to access point 104a as part of classification response 128.

In certain implementations, method 400 could include steps in which network management system 106 receives, from network traffic classification service 108, a classification information update 134 that includes classification information for network traffic, as maintained by network traffic classification service 108 and described elsewhere in this disclosure. Network management system 106 may store some or all of the classification information included in the received classification information update 134 in centralized cache 118.

In certain implementations, method 400 could include steps in which network management system 106 transmits, to some or all of the access points 104 for which network management system 106 provides traffic classification services, a classification information update 136 that includes classification information for network traffic, such as at least a portion of the classification information 120 stored in centralized cache 118. Classification information update 136 may include classification information obtained by network management system 106 from access point 104a, one or more access points 104 other than access point 104a, network traffic classification service 108, and/or any other suitable classification information source.

In certain implementations, method 400 could continue and/or be repeatedly performed as network management system 106 receives, from client device 102a and/or other client devices 102, additional classification requests (e.g., similar to classification request 126) for classification information for network traffic 112. The additional network traffic 112 might or might not be the same as network traffic 112a for traffic classification purposes. As just one example, method 400 may include network management system 106 receiving, from a client device 102 (e.g., client device 102a, 102b, or 102c), an additional classification request (e.g., similar to classification request 126) for additional network traffic 112 from a client device 102 (e.g., client device 102a, 102b, or 102c).

Continuing with this example, in response to the additional classification request, network management system 106 may attempt to obtain classification information for the additional network traffic 112 from classification information 120 in centralized cache 118. In response to determining that classification information 120 in centralized cache 118 includes classification information for the additional network traffic 112, network management system 106 may retrieve a copy of the classification information for the additional network traffic 112 from classification information 120 of centralized cache 118, and may include that classification information in a classification response transmitted by network management system 106 to the access point 104 that communicated the additional classification request. On the other hand, in response to determining that classification information 120 in centralized cache 118 does not include classification information for the additional network traffic 112, network management system 106 may attempt to obtain classification information for the additional network traffic 112 from network traffic classification service 108 in a manner similar to that described above with reference to step 408 and elsewhere in this disclosure, and then in response to receiving, from network traffic classification service 108, the classification information for the additional network traffic 112, network management system 106 may transmit the classification information for the additional network traffic 112 to the access point 104 that transmitted the additional classification request.

In response to determining that classification information 114a in local cache 116a does not include classification information for the additional network traffic 112, access point 104a may attempt to obtain the classification information for the additional network traffic 112 from network management system 106. For example, access point 104a may transmit, to network management system 106, a classification request (e.g., similar to classification request 126) for classification information for the additional network traffic 112, and may receive, from network management system 106, the classification information for the additional network traffic 112. In response to receiving the classification information for the additional network traffic 112, access point 104a may process the additional network traffic 112 according to the classification information for the additional network traffic 112.

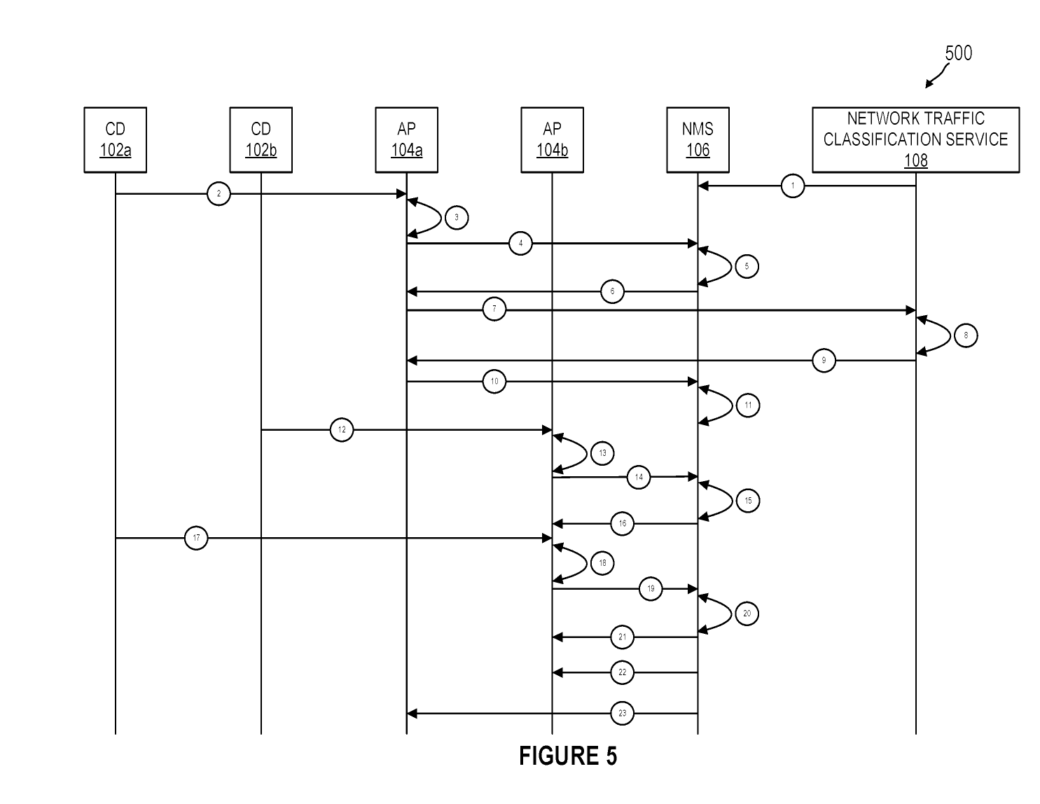

FIG. 5 illustrates an example signaling flow 500 for classification of network traffic using a centralized cache of network information, according to certain implementations. In certain implementations, signaling flow 500 may correspond to the operations described above with reference to FIG. 1B, and throughout the description of signaling flow 500, reference may be made to items appearing in FIG. 1B for example purposes. In the illustrated example, signaling flow 500 involves communication between/among access client devices 102a and 102b (abbreviated as CD 102a and CD 102b, respectively), access points 104a and 104b (abbreviated as AP 104a and AP 104b, respectively), network management system 106 (abbreviated as NMS 106), and network traffic classification service 108. Furthermore, communication between entities of system 100 may occur over network 110. The following describes steps 1 through 23 of the example signaling flow 500 of FIG. 5.

As with the example of FIG. 1A, in this example signaling flow 500, network management system 106 manages multiple access points 104 (e.g. at least access points 104a and 104b), and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is provided to access point 104a. Although described with reference to client device 102a, client device 102b, access point 104a, access point 104b, and network traffic 112a, other access points 104 (e.g., access point 104c) may operate similarly when processing network traffic 112 from client devices 102.

Steps 1 through 5 of signaling flow 500 may generally correspond to steps 1 through 5 of signaling flow 200, described above, and the details are not repeated. In signaling flow 500, at step 6, in response to determining at step 5 that classification information 120 in centralized cache 118 does not include classification information for network traffic 112a, then at step 6, network management system 106 may transmit a classification response 128 that includes a null response. A null response may indicate (whether explicitly, by the formatting/type of the message, or otherwise) that network management system 106 lacks classification information for network traffic 112a.

Access point 104a may receive the classification response 128 including the null response, and, at steps 7-9, in response to this null response, access point 104a may attempt to obtain classification information for network traffic 112a (e.g., directly) from network traffic classification service 108. For example, at step 7, in response to the null response, access point 104a may transmit a classification request 138 (e.g., directly) to network traffic classification service 108 to attempt to obtain classification information for network traffic 112a from network traffic classification service 108. Classification request 138 may include some or all of the metadata (e.g., for network traffic 112a) that access point 104a extracted or otherwise determined from network traffic 112a and included as part of classification request 126. In certain implementations, system 100 may include multiple network traffic classification services 108, and access point 104a may transmit classification requests 138 to some or all of those network traffic classification services 108 to attempt to obtain classification information for network traffic 112a.

At step 8, network traffic classification service 108 may receive classification request 138 and may retrieve the classification information for network traffic 112a from classification information 124 in storage device 122. At step 9, network traffic classification service 108 may transmit the classification information for network traffic 112a (retrieved from classification information 124) to access point 104a as classification response 140.

Access point 104a may receive classification response 140 that includes classification information for network traffic 112a, and may store the classification information from classification response 140 in local cache 116a as part of classification information 120 so that the classification information for network traffic 112a might be available locally to access point 104a for at least some period of time in the future, thereby reducing or eliminating future requests to network management system 106 and/or network traffic classification service 108 for the classification information for network traffic 112a. Access point 104a can then process network traffic 112a using the classification information received from network traffic classification service 108 as part of classification response 140. The particular action performed by access point 104a would depend on the particular implementation and associated traffic policies being applied by access point 104a.

At step 10, in response to receiving classification response 140 that includes classification information for network traffic 112a, access point 104a may transmit the classification information for network traffic 112a to network management system 106 as part classification information update 142. Network management system 106 may receive classification information update 142 that includes classification information for network traffic 112a. Network management system 106 may store the classification information from classification information update 142 in centralized cache 118 as part of classification information 120 so that the classification information for network traffic 112a might be available locally to network management system 106 for at least some period of time in the future to provide to requesting access points 104, thereby reducing or eliminating future requests to network traffic classification service 108 for the classification information for network traffic 112a.

Steps 12 through 21 of signaling flow 500 illustrate example subsequent network traffic 112 and how that network traffic might be classified in view of the prior classification of network traffic 112. Steps 12 through 21 of signaling flow 500 may generally correspond to steps 11 through 20 of signaling flow 200, described above, and the details are not repeated.

At steps 22 and 23, network management system 106 may transmit a classification information update 136 to access point 104b and access point 104a, respectively. The illustrated order of steps 22 and 23 is arbitrary and could be reversed, or steps 22 and 23 could be performed at least partially simultaneously, if appropriate.

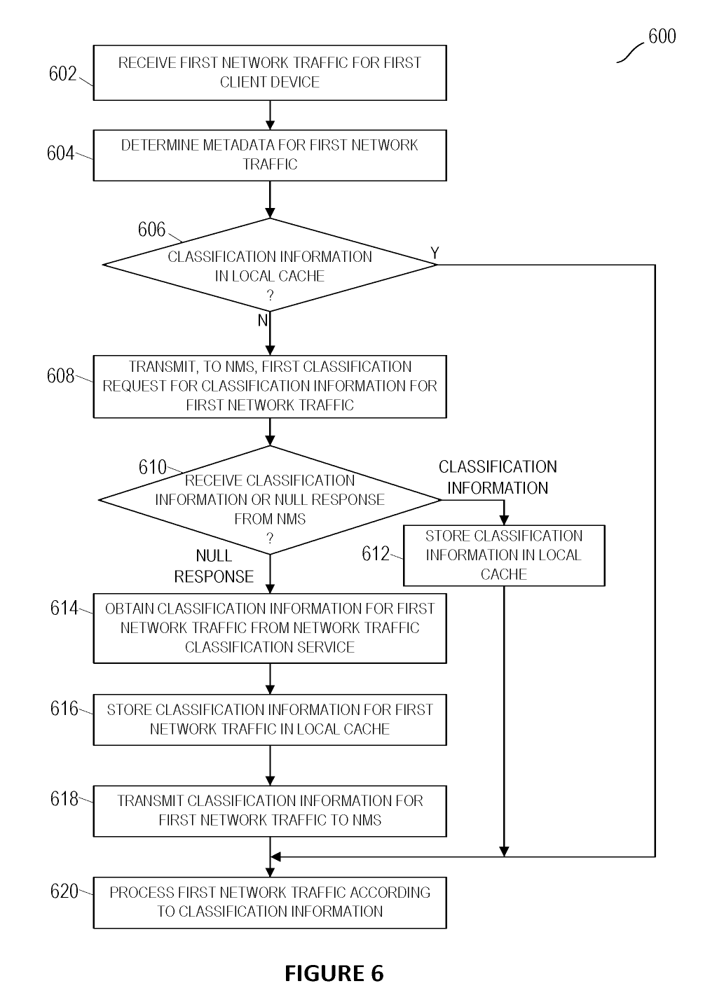

FIG. 6 illustrates an example method 600 for classification of network traffic using a centralized cache of network information, according to certain implementations. In certain implementations, method 600 may correspond to certain operations described above with reference to FIG. 1B and signaling flow 500 of FIG. 5. Reference may be made to items appearing in FIG. 1B for example purposes. In certain implementations, some or all of the steps described with reference to method 600 may be performed by an access point 104, which for purposes of this example will be described as access point 104a.

As with the example of FIGS. 1A and 5, in this example method 600, network management system 106 manages multiple access points 104 (e.g. at least access points 104a and 104b), and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is received by access point 104a. Although described with reference to client device 102a, access point 104a, and network traffic 112a, other access points 104 (e.g., access points 104b and 104c) may operate similarly when processing network traffic 112 from client devices 102.

At step 602, access point 104a may receive network traffic 112a from client device 102a. For example, client device 102a may connect to or may already be connected to access point 104a and may transmit network traffic 112a to access point 104a. As particular examples, and as described above, client device 102a may generate network traffic 112a by accessing applications, websites, or other content, and that network traffic 112a may traverse access point 104a en route to a communication network (e.g., a portion of network 110).

At step 604, access point 104a may determine metadata for network traffic 112a. For example, access point 104a may extract or otherwise determine metadata from network traffic 112a. As described above, the metadata may include certain attributes of the network traffic 112 that may be used to identify the network traffic.

At step 606, access point 104a may determine whether classification information 114a in local cache 116a includes classification information for network traffic 112a. In other words, prior to engaging another entity (e.g., network management system 106 and/or network traffic classification service 108) to obtain classification information for network traffic 112a (e.g., by transmitting a classification request 126 to network management system 106 and/or a classification request 138 to network traffic classification service 108), access point 104a may

As described above, classification information for network traffic 112 may provide a network traffic profile for network traffic 112 and may include traffic category information, traffic reputation information, and/or any other suitable information. In certain implementations, access point 104a may use some or all of the metadata determined from network traffic 112a at step 604 to search classification information 114a for classification information applicable to network traffic 112a. As just one example, the metadata for network traffic 112a may include a URL for a web site or other content associated with network traffic 112a, and access point 104a may search classification information 114a for classification data associated with that URL.

If access point 104a determines at step 606 that classification information 114a in local cache 116a includes classification information for network traffic 112a, then access point 104a may proceed to step 620, described below. If, on the other hand, access point 104a determines at step 606 that classification information 114a in local cache 116a does not include classification information for network traffic 112a, then at steps 608-612, access point 104a may attempt to obtain classification information for network traffic 112a from network management system 106.

At step 608, access point 104a may transmit a classification request 126 to network management system 106 to attempt to obtain classification information for network traffic 112a. Classification request 126 may include some or all of the metadata determined from network traffic 112a at step 304.

At step 610, access point 104a may determine whether classification information for network traffic 112a has been received from network management system 106 or whether a null response has been received from network management system 106. In certain implementations, access point 104a may make this determination based on a type of classification response 128 received from network management system 106 (e.g., in response to classification request 126). For example, classification response 128 may include classification information for network traffic 112a, and access point 104a may determine that classification information for network traffic 112a has been received based on this type of classification response 128. As another example, classification response 128 may be a null response, which may indicate (whether explicitly, by the formatting/type of the message, or otherwise) that network management system 106 lacks classification information for network traffic 112a, and access point 104a may determine that classification information for network traffic 112a has not been received based on this type of classification response 128. As another example, access point 104a may fail to receive, after a predetermine time, any response from network management system 106 in response to classification request 126, which access point 104a may treat as a classification response 128 that includes a null response, or may handle in any other suitable manner.

If access point 104a determines at step 610 that access point 104a has received classification information for network traffic 112a from network management system 106, then at step 612, in response to receiving the classification information for network traffic 112a, access point 104a may store the classification information for network traffic 112a as part of classification information 114a in local cache 116a, so that access point 104a may have a quickly accessible local copy of classification information for network traffic 112a for at least some period of time in the future. Method 600 then may proceed to step 620, described below.

If, on the other hand, access point 104a determines at step 610 that access point 104a received a null response (e.g., a classification response 128 that includes a null response) from network management system 106, then at step 614, access point 104a may attempt to obtain classification information for network traffic 112a (e.g., directly) from network traffic classification service 108. For example, in response to the null response, access point 104a may transmit a classification request 138 (e.g., directly) to network traffic classification service 108 to attempt to obtain classification information for network traffic 112a from network traffic classification service 108. Classification request 138 may include some or all of the metadata (e.g., for network traffic 112a) that access point 104a extracted or otherwise determined from network traffic 112a and included as part of classification request 126. Access point 104a may receive classification response 140 that includes classification information for network traffic 112a. At step 616, access point may store the classification information from classification response 140 in local cache 116a as part of classification information 120 so that the classification information for network traffic 112a might be available locally to access point 104a for at least some period of time in the future, thereby reducing or eliminating future requests to network management system 106 and/or network traffic classification service 108 for the classification information for network traffic 112a.

At step 618, in response to receiving classification response 140 that includes classification information for network traffic 112a from network traffic classification service 108, access point 104a may transmit the classification information for network traffic 112a to network management system 106 as part classification information update 142. This may allow network management system 106 to store the classification information from classification information update 142 in centralized cache 118 as part of classification information 120 so that the classification information for network traffic 112a might be available locally to network management system 106 for at least some period of time in the future to provide to requesting access points 104, thereby reducing or eliminating future requests to network traffic classification service 108 for the classification information for network traffic 112a.

At step 620, access point 104a may process network traffic 112a using the obtained classification information for network traffic 112a. For example, if access point 104a was able to locate classification information for network traffic 112a in classification information 114a of local cache 116a (at step 606), then at step 620, access point 104a may retrieve the classification information for network traffic 112a from classification information 114a of local cache 116a, and may process network traffic 112a according to the classification information for network traffic 112a retrieved from classification information 114a of local cache 116a. As another example, if access point 104a obtains classification information for network traffic 112a from network management system 106 (e.g., via a classification response 128 received at step 610), then at step 620, access point 104a may access the classification information for network traffic 112a, and may process network traffic 112a according to the classification information for network traffic 112a received from network management system 106. As another example, if access point 104a obtains classification information for network traffic 112a from network traffic classification service 108 (e.g., via a classification response 140 received at step 614), then at step 620, access point 104a may access the classification information for network traffic 112a, and may process network traffic 112a according to the classification information for network traffic 112a received from network traffic classification service 108.

For example, access point 104a may enforce one or more network policies on network traffic 112a according to the classification information for network traffic 112a. The particular action performed by access point 104a would depend on the particular implementation and associated traffic policies being applied by access point 104a.

In certain implementations, method 600 could include steps in which access point 104a receives, from network management system 106, a classification information update 136 that includes classification information obtained by network management system 106 from access point 104a, one or more access points 104 other than access point 104a, network traffic classification service 108, and/or any other suitable classification information source. Access point 104a may store some or all of the classification information included in the received classification information update 136 in local cache 116a.

In certain implementations, method 600 could continue and/or be repeatedly performed as access point 104a receives additional network traffic 112 from client device 102a and/or other client devices 102. The additional network traffic 112 might or might not be the same as network traffic 112a for traffic classification purposes. As just one example, method 600 may include access point 104a receiving additional network traffic 112 from client device 102a or another client device (e.g., client device 102b or client device 102c). Access point 104a may attempt to obtain classification information for the additional network traffic 112 from classification information 114a in local cache 116a. In response to determining that classification information 114a in local cache 116a does not include classification information for the additional network traffic 112, access point 104a may attempt to obtain the classification information for the additional network traffic 112 from network management system 106. For example, access point 104a may transmit, to network management system 106, a classification request (e.g., similar to classification request 126) for classification information for the additional network traffic 112, and may receive, from network management system 106, the classification information for the additional network traffic 112 or a null response. In response to receiving the classification information for the additional network traffic 112, access point 104a may process the additional network traffic 112 according to the classification information for the additional network traffic 112. In response to receiving a null response from network management system 106, access point 104a may attempt to obtain the classification information for the additional network traffic 112 from network traffic classification service 108, and once obtained, may transmit the obtained classification information for the additional network traffic 112 to network management system 106, allowing network management system 106 to store the classification information in centralized cache 118.

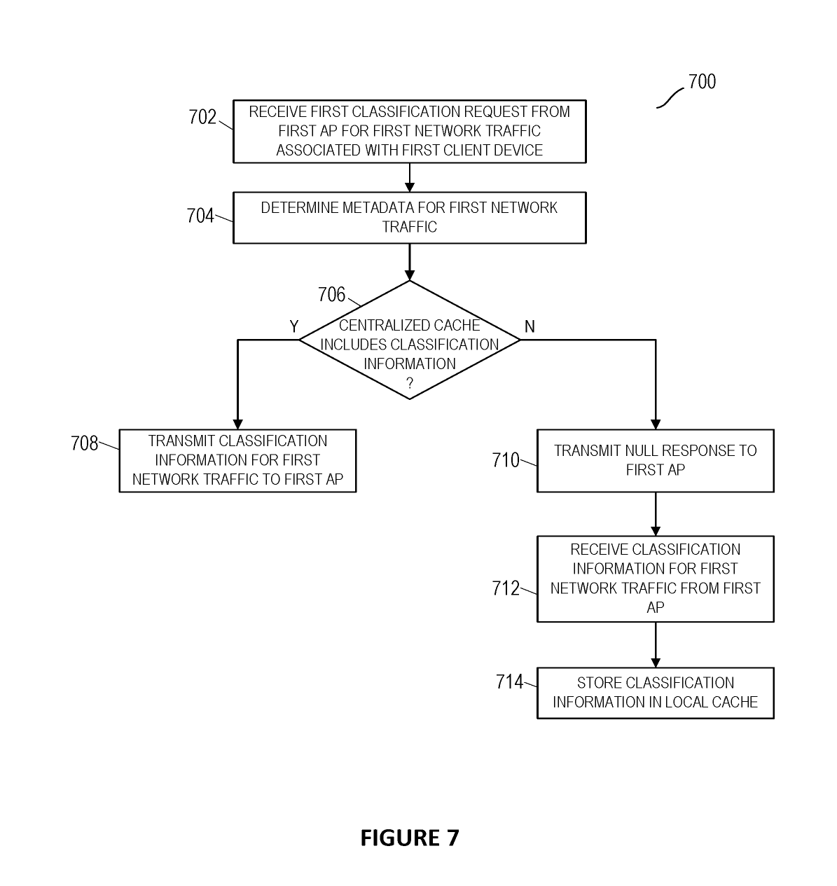

FIG. 7 illustrates an example method 700 for classification of network traffic using a centralized cache of network information, according to certain implementations. In certain implementations, method 700 may correspond to certain operations described above with reference to FIG. 1B and signaling flow 500 of FIG. 5. Reference may be made to items appearing in FIG. 1B for example purposes. In certain implementations, some or all of the steps described with reference to method 700 may be performed by network management system 106.

As with the example of FIGS. 1B and 5, in this example method 700, network management system 106 manages multiple access points 104 (e.g. at least access points 104a and 104b), and includes centralized cache 118 that stores at least some classification information 120 for network traffic (e.g., network traffic 112) that might be generated by client devices 102 of the access points 104 (e.g., client device 102a of access point 104a). For purposes of providing an example network traffic classification process, the following description focuses on a scenario in which client device 102a generates network traffic 112a that is received by access point 104a, and for which access point 104a attempts to obtain classification information from network management system 106. Although described with reference to client device 102a, access point 104a, and network traffic 112a, network management system 106 may operate similarly when processing request for classification information for other network traffic 112 of access point 104a or network traffic 112 from other client devices 102.

At step 702, network management system 106 may receive a classification request 126 from access point 104a. Classification request 126 may request classification information for network traffic 112a, which may be associated with a client device 102a from which access point 104a received network traffic 112a. Classification request 126 may include some or all of the metadata that access point 104a extracted or otherwise determined from network traffic 112a, as described elsewhere in this disclosure.

At step 704, network management system 106 may determine the metadata for network traffic 112a. For example, network management system 106 may access classification request 126 and extract or otherwise determine some or all of the metadata for network traffic 112a from classification request 126.

At step 706, network management system 106 may determine whether classification information 120 in centralized cache 118 includes classification information for network traffic 112a. In certain implementations, network management system 106 may use the metadata determined at step 704 to search classification information 120 for classification information applicable to network traffic 112a.

If network management system 106 determines at step 706 that classification information 120 in centralized cache 118 includes classification information for network traffic 112a, then method 700 may proceed to step 708. At step 708, in response to determining that classification information 120 in centralized cache 118 includes classification information for network traffic 112a, network management system 106 may transmit the classification information for network traffic 112a to the requesting access point 104 (e.g., access point 104a) as classification response 128. For example, network management system 106 may retrieve the classification information for network traffic 112a from centralized cache 118 and transmit a classification response 128 to access point 104a that includes the classification information for network traffic 112a.

Returning to step 706, if network management system 106 determines that classification information 120 in centralized cache 118 does not include classification information for network traffic 112a, then method 700 may proceed to step 710. At step 710, in response to determining at step 706 that classification information 120 in centralized cache 118 does not include classification information for network traffic 112a, then network management system 106 may transmit to access point 104a a classification response 128 that includes a null response. A null response may indicate (whether explicitly, by the formatting/type of the message, or otherwise) that network management system 106 lacks classification information for network traffic 112a.

As described elsewhere in this disclosure, in response to receiving classification response 140 that includes classification information for network traffic 112a, in some implementations access point 104a may attempt to obtain classification information for network traffic 112a from another source (e.g., network traffic classification service 108). If access point 104a is able to obtain the classification information for network traffic 112a from another source, then access point 104a might transmit the obtained classification information for network traffic 112a to network management system 106 as a classification information update 142. Thus, at step 712, network management system 106 may receive classification information update 142 that includes classification information for network traffic 112a. At step 714, network management system 106 may store the classification information from classification information update 142 in centralized cache 118 as part of classification information 120 so that the classification information for network traffic 112a might be available locally to network management system 106 for at least some period of time in the future to provide to requesting access points 104, thereby reducing or eliminating future requests to network traffic classification service 108 for the classification information for network traffic 112a.

In certain implementations, method 700 could include steps in which network management system 106 receives, from network traffic classification service 108, a classification information update 134 that includes classification information for network traffic, as maintained by network traffic classification service 108 and described elsewhere in this disclosure. Network management system 106 may store some or all of the classification information included in the received classification information update 134 in centralized cache 118.

In certain implementations, method 700 could include steps in which network management system 106 transmits, to some or all of the access points 104 for which network management system 106 provides traffic classification services, a classification information update 136 that includes classification information for network traffic, such as at least a portion of the classification information 120 stored in centralized cache 118. Classification information update 136 may include that include classification information obtained by network management system 106 from access point 104a, one or more access points 104 other than access point 104a, network traffic classification service 108, and/or any other suitable classification information source.

In certain implementations, method 700 could continue and/or be repeatedly performed as network management system 106 receives, from client device 102a and/or other client devices 102, additional classification requests (e.g., similar to classification request 126) for classification information for network traffic 112. The additional network traffic 112 might or might not be the same as network traffic 112a for traffic classification purposes. As just one example, method 700 may include network management system 106 receiving, from a client device 102 (e.g., client device 102a, 102b, or 102c), an additional classification request (e.g., similar to classification request 126) for additional network traffic 112 from a client device 102 (e.g., client device 102a, 102b, or 102c).

Continuing with this example, in response to the additional classification request, network management system 106 may attempt to obtain classification information for the additional network traffic 112 from classification information 120 in centralized cache 118. In response to determining that classification information 120 in centralized cache 118 includes classification information for the additional network traffic 112, network management system 106 may retrieve a copy of the classification information for the additional network traffic 112 from classification information 120 of centralized cache 118, and may include that classification information in a classification response transmitted by network management system 106 to the access point 104 that communicated the additional classification request. On the other hand, in response to determining that classification information 120 in centralized cache 118 does not include classification information for the additional network traffic 112, network management system 106 may transmit to the access point 104 that transmitted the additional classification request a classification response 128 that includes a null response. If the access point 104 that transmitted the additional classification request to network management system 106 is able to obtain the classification information for the additional network traffic 112 from another source, then network management system 106 may receive a classification information update (e.g., similar to classification information update 142) that includes classification information for the additional network traffic 112, and may store the received classification information from the classification information update in centralized cache 118 as part of classification information 120, which may provide certain benefits, as described above.

FIG. 8 illustrates a system 800 including additional details of certain components of FIGS. 1A-1B, according to certain implementations. In particular, system 800 includes a selected access point 104 (providing a representation of any one of access points 104 of FIGS. 1A through 1B), network management system 106, and network traffic classification service 108, all connected by a network 110, described above with reference to FIGS. 1A and 1B. Each of access point 104, network management system 106, and network traffic classification service 108 may be implemented using any suitable combination of hardware, firmware, and software.

In the illustrated example, access point 104 includes one or more processors 802, one or more memories 804, and one or more communication interfaces 806, all configured to communicate via one or more links 808. These components are described in greater detail below.

The one or more memories 804 may store classification engine 810, enforcement engine 812, network traffic policies 814, and local cache 116 (storing classification information 114). Classification engine 810 may be configured to execute or otherwise facilitate operations that access point 104 performs in connection with classifying network traffic 112 as described throughout this disclosure. Enforcement engine 812 may be configured to execute or otherwise facilitate operations that access point 104 performs in connection with enforcing network traffic policies 814 on network traffic 112 according to the traffic classification determined for that network traffic 112 as described throughout this disclosure. Network traffic policies 814 may include those policies that access point 104 (e.g., enforcement engine 812) might enforce based on the classification determined for network traffic 112. In certain implementations, access point 104 might receive some or all of network traffic policies from network management system 106. This disclosure describes local cache 116 and classification information 114 previously.

In the illustrated example, network management system 106 includes one or more processors 816, one or more memories 818, and one or more communication interfaces 820, all configured to communicate via one or more links 822. These components are described in greater detail below.

The one or more memories 818 may store classification engine 824, network traffic policies 826, and centralized cache 118 (storing classification information 120). Classification engine 824 may be configured to execute or otherwise facilitate operations that network management system 106 performs in connection with classifying network traffic 112 as described throughout this disclosure. Network traffic policies 826 may include those policies that network management system 106 may distributed to access points 104 for enforcement based on the classifications determined for network traffic 112. This disclosure describes centralized cache 118 and classification information 120 previously.

In the illustrated example, network traffic classification service 108 includes one or more processors 828, one or more memories 830, and one or more communication interfaces 832, all configured to communicate via one or more links 834. These components are described in greater detail below.

The one or more memories 830 may store classification engine 836 and storage device 122 (storing classification information 124). Classification engine 836 may be configured to execute or otherwise facilitate operations that network traffic classification service 108 performs in connection with classifying network traffic 112 as described throughout this disclosure. This disclosure describes centralized cache 118 and classification information 120 previously.

Each of the one or more processors 802, one or more processors 816, and one or more processors 828 may be any component or collection of components adapted to perform computations and/or other processing-related tasks. Each of the one or more processors 802, one or more processors 816, and one or more processors 828 may include one or more processing cores, and can be, for example, a microprocessor, a microcontroller, a control circuit, a digital signal processor, a field-programmable gate array (FPGA), an application-specific integrated circuit (ASIC), a system-on-chip (SoC), or combinations thereof. Each of the one or more processors 802, one or more processors 816, and one or more processors 828 may include any suitable number of processors, or multiple processors may collectively form a single processor.

Each of the one or more memories 804, one or more memories 818, and one or more memories 830 may include any suitable combination of volatile memory, non-volatile memory, and/or virtualizations thereof. For example, each of the one or more memories 804, one or more memories 818, and one or more memories 830 may include any suitable combination of magnetic media, optical media, RAM, ROM, removable media, and/or any other suitable memory device. Each of the one or more memories 804, one or more memories 818, and one or more memories 830 may include data structures used to organize and store all or a portion of the stored data. Each of the one or more memories 804, one or more memories 818, and one or more memories 830 may include a non-transitory computer-readable medium that stores programming for execution by one or more of the one or more processors 802, one or more processors 816, or one or more processors 828, respectively.

For each of the one or more memories 804, one or more memories 818, and one or more memories 830, the memory may be considered a computer-readable medium on which computer code (e.g., instructions, such as may be associated with classification engine 810, enforcement engine 812, network traffic policies 814, classification engine 824, network traffic policies 826, and classification engine 836, as the case may be) is stored. References to computer-readable medium, computer-readable storage medium, computer program product, tangibly embodied computer program, or the like, or a controller, circuitry, computer, processor, or the like should be understood to encompass not only computers having different architectures such as single or multi-processor architectures and sequential (Von Neumann) or parallel architectures but also specialized circuits such as FPGAs, ASICs, signal processing devices, and other devices. References to computer program, instructions, logic, code, or the like, should be understood to encompass software for a programmable processor or firmware such as, for example, the programmable content of a hardware device whether instructions for a processor, or configuration settings for a fixed-function device, gate array or programmable logic device, or the like.

Classification engine 810, enforcement engine 812, network traffic policies 814, classification engine 824, network traffic policies 826, and classification engine 836 may be implemented using any suitable combination of hardware, firmware, and software. In certain implementations, one or more of classification engine 810, enforcement engine 812, network traffic policies 814, classification engine 824, network traffic policies 826, and classification engine 836 may be embodied at least partially in software. For example, one or more of classification engine 810, enforcement engine 812, network traffic policies 814, classification engine 824, network traffic policies 826, and classification engine 836 may be implemented at least partially as programming for execution by one or more processors (e.g., one or more associated processors described above), the programming comprising instructions to perform some or all of the functionality described elsewhere in this disclosure.

Each of the one or more communication interfaces 806, one or more communication interfaces 820, and one or more communication interfaces 832 represent any suitable computer element that can receive information from a communication network (e.g., network 110) and transmit information through a communication network (e.g., network 110), or both. Each of the one or more communication interfaces 806, one or more communication interfaces 820, and one or more communication interfaces 832 may facilitate wireless and/or wired communication, and may represent any port or connection, real or virtual, including any suitable combination of hardware, firmware, and software, including protocol conversion and data processing capabilities, to communicate through a LAN, WAN, or other communication system that allows information to be exchanged.

Links 808, 822, and 834 may include any suitable wired or wireless communication medium for the components of access point 104, network management system 106, and network traffic classification service 108, respectively, to communicate with one another. For example, links 808, 822, and 834 may include any suitable combination of a bus or communication network.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computing device, comprising:
one or more processors; and
one or more non-transitory computer-readable storage media storing programming for execution by the one or more processors, the programming comprising instructions to:
receive, at a first access point, first network traffic for a first client device;
transmit, from the first access point to a network management system, a first classification request for classification information for the first network traffic;
receive, at the first access point from the network management system, a null response indicating that the network management system lacks classification information for the first network traffic;
obtain, by the first access point in response to the null response, the classification information for the first network traffic from a network traffic classification service; and
process the first network traffic according to the classification information for the first network traffic.

2. The computing device of claim 1, wherein the classification information comprises one or more of network traffic category information or network traffic reputation information.

3. The computing device of claim 1, wherein the instructions to obtain, by the first access point in response to the null response from the network traffic classification service comprise instructions to:
transmit, by the first access point to the network traffic classification service, a second classification request for the classification information for the first network traffic; and
receive the classification information for the first network traffic from the network traffic classification service.

4. The computing device of claim 1, wherein the instructions to process the first network traffic according to the classification information received from the network traffic classification service comprise instructions to enforce, by the first access point, a network policy on the first network traffic based on the classification information received from the network traffic classification service.

5. The computing device of claim 1, wherein:
the computing device comprises a local cache of classification information; and
the programming further comprises instructions to:
store the classification information for the first network traffic in the local cache; and
transmit the classification information for the first network traffic to the network management system for storage in a centralized cache of the network management system.

6. The computing device of claim 1, wherein:
the computing device comprises a local cache of classification information; and
the programming comprises instructions to:
determine, prior to transmitting to the network management system the first classification request for classification information for the first network traffic, whether the local cache includes the classification information for the first network traffic; and
transmit the first classification request to the network management system in response to determining that the local cache does not include the classification information for the first network traffic.

7. The computing device of claim 1, wherein:
the computing device comprises a local cache of classification information; and
the programming further comprises instructions to:
receive, from the network management system, a classification information update, the classification information update comprising classification information obtained by the network management system from at least a second access point different than the first access point; and
store classification information included in the classification information update in the local cache.

8. The computing device of claim 1, wherein the programming further comprises instructions to:
receive, at the first access point, second network traffic for a second client device, the second client device being the first client device or a different client device;
transmit, from the first access point to the network management system, a first classification request for classification information for the second network traffic;
receive, at the first access point from the network management system, the classification information for the second network traffic; and
process the second network traffic according to the classification information for the second network traffic.

9. The computing device of claim 1, wherein the first network traffic comprises one or more of:
a network communication generated by an application hosted on the first client device;
a network communication generated by a web application; or
a network communication generated to interact with a website.

10. A computing device, comprising:
a centralized cache storing classification information for network traffic associated with a plurality of access points managed by the computing device;
one or more processors; and
one or more non-transitory computer-readable storage media storing programming for execution by the one or more processors, the programming comprising instructions to:
receive, at a network management system, a first classification request from a first access point of the plurality of access points for first network traffic associated with a first client device of the first access point;
determine, in response to the first classification request, whether the centralized cache includes classification information for the first network traffic;
obtain, in response to determining that the centralized cache includes the classification information for the first network traffic, the classification information for the first network traffic from the centralized cache;
obtain, in response to determining that the centralized cache does not include the classification information for the first network traffic, the classification information for the first network traffic from a network traffic classification service; and
transmit the classification information for the first network traffic to the first access point.

11. The computing device of claim 10, wherein the classification information comprises one or more of network traffic category information or network traffic reputation information.

12. The computing device of claim 10, wherein the instructions to determine, in response to the first classification request, whether the centralized cache includes classification information for the first network traffic comprise instructions to:
access metadata of the first network traffic determined from the first classification request; and
search, according to the metadata, the centralized cache for the classification information for the first network traffic.

13. The computing device of claim 10, wherein the instructions to obtain, in response to determining that the centralized cache does not include the classification information for the first network traffic, the classification information for the first network traffic from the network traffic classification service comprise instructions to:
transmit, by the network management system to the network traffic classification service, a second classification request for the classification information for the first network traffic; and
receive, by the network management system, the classification information for the first network traffic from the network traffic classification service.

14. The computing device of claim 10, wherein:
determining whether the centralized cache includes the classification information for the first network traffic comprises determining that the centralized cache includes the classification information for the first network traffic; and
obtaining, in response to determining that the centralized cache does not include the classification information for the first network traffic, the classification information for the first network traffic from a network traffic classification service; and
the programming further comprises instructions to store, in the centralized cache, the classification information for the first network traffic obtained from the network traffic classification service.

15. The computing device of claim 10, wherein the programming further comprises instructions to:
receive, at the network management system, a second classification request from a second access point of the plurality of access points for second network traffic associated with a second client device of the second access point, the second network traffic being the same as the first network traffic for traffic classification purposes;
determine, in response to the second classification request, that the centralized cache includes the classification information for the second network traffic, the classification information for the second network traffic being the classification information previously obtained by the network management system for the first network traffic; and
transmit, in response to determining that the centralized cache includes the classification information for the second network traffic, the classification information for the second network traffic to the second access point.

16. The computing device of claim 15, wherein the first client device and the second client device are a same client device.

17. The computing device of claim 15, wherein the first access point and the second access point are associated with different customer identifiers, the centralized cache storing classification information for a customer identifier associated with the first access point and for a customer identifier associated with the second access point.

18. The computing device of claim 10, wherein the programming further comprises instructions to:
receive, from the network traffic classification service, a classification information update, the classification information update comprising classification information; and
store classification information included in the classification information update in the centralized cache.

19. The computing device of claim 10, wherein the programming further comprises instructions to transmit, a classification information update to one or more of the plurality of access points, the classification information update comprising at least a portion of the classification information stored in the centralized cache.

20. A computing device, comprising:
a centralized cache storing classification information for network traffic associated with a plurality of access points managed by the computing device;
one or more processors; and
one or more non-transitory computer-readable storage media storing programming for execution by the one or more processors, the programming comprising instructions to:
receive, at a network management system, a first classification request from a first access point of the plurality of access points for first network traffic associated with a first client device of the first access point;
determine, in response to the first classification request, whether the centralized cache includes classification information for the first network traffic;
transmit, in response to determining that the centralized cache includes the classification information for the first network traffic, the classification information for the first network traffic to the first access point;
transmit, in response to determining that the centralized cache does not include the classification information for the first network traffic, a null response to the first access point, the null response indicating that the network management system lacks classification information for the first network traffic;
receive, by the network management system from the first access point, the classification information for the first network traffic, the first access point having obtained the classification information for the first network traffic from a network traffic classification service in response to the null response from the network management system; and
store, in response to receiving the classification information for the first network traffic from the first access point, the classification information for the first access point in the centralized cache.
